(19) United States
(12) Patent Application Publication
(10) Pub. No.: US 2006/0006360 A1
(43) Pub. Date: Jan. 12, 2006

(54) Grain oriented ceramics and production method thereof

(75) Inventors: Hisaaki Takao, Aichi (JP); Takahiko Homma, Aichi (JP); Yasuyoshi Saito, Aichi (JP); Kazumasa Takatori, Aichi (JP); Tatsuhiko Nonoyama, Chiryu-city (JP); Toshiatsu Nagaya, Kuwana-city (JP); Masaya Nakamura, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/156,328

(22) Filed: Jun. 17, 2005

(30) Foreign Application Priority Data
Jun. 17, 2004 (JP) 2004-180204
Sep. 13, 2004 (JP) 2004-266129

(51) Int. Cl. C04B 35/00

(52) U.S. Cl. 252/62.9 R; 501/134; 252/62.3 T

(57) ABSTRACT

To provide a grain oriented ceramic capable of exerting excellent piezoelectric properties, a production method thereof, and a piezoelectric material, a dielectric material, a thermoelectric conversion element and an ion conducting element each using the grain oriented ceramic, there is provided a grain oriented ceramic comprising, as the main phase, an isotropic perovskite-type compound which is represented by formula (1): {Liₓ(K_{1-y}Na_{y})₁₋ₓ}(Nb_{1-z-w}Ta_{z}Sb_{w})O₃ in which x, y, z and w are in respective composition ranges of 0≦x≦0.2, 0≦y≦1, 0≦z≦0.4, 0≦w≦0.2 and x+z+w>0. The main phase comprises a polycrystalline body containing from 0.0001 to 0.15 mol of any one or more additional element selected from metal elements, semimetal elements, transition metal elements, noble metal elements and alkaline earth metal elements belonging to Groups 2 to 15 of the Periodic Table, per mol of the compound represented by formula (1). A specific crystal plane of each crystal grain constituting said polycrystalline body is oriented.

### TECHNICAL FIELD

The present invention relates to grain oriented ceramics not containing lead in the composition, a production method thereof, to a piezoelectric element, to a dielectric element, to a thermoelectric conversion element and to an ion conducting element.

### BACKGROUND ART

The piezoelectric materials having a piezoelectric effect are classified into single crystal, ceramic, thin film, polymer and composite (composite material). Among these, a piezoelectric ceramic is being widely used as various sensors, energy conversion elements, capacitors and the like in the field of electronics or mechatronics because ceramic has high performance and high degree of freedom in shape and the design of materials is relatively easy.

The piezoelectric ceramic is obtained by subjecting a ferroelectric ceramic to a so-called poling process of applying an electric field to align the direction of polarization of the ferroelectric material to a fixed direction. In order to align spontaneous polarization to a fixed direction by a poling process in the piezoelectric ceramic, an isotropic perovskite-type crystal structure capable of giving three-dimensionally directed spontaneous polarization is advantageous. Therefore, most piezoelectric ceramics in practical use are isotropic perovskite-type ferroelectric ceramics.

As for the isotropic perovskite-type ferroelectric ceramic, for example, lead-containing PZT (PbTiO₃—PbZrO₃) component-based ceramics have been used. The piezoelectric ceramic comprising PZT has good piezoelectric properties as compared with other piezoelectric ceramics. However, the piezoelectric ceramic comprising PZT or the like contains lead in its constituent elements and bears a risk that the harmful lead dissolves out from the industrial waste or the like to cause environmental pollution. Also, with recent increasing awareness of environmental issues, there is a tendency to avoid the production of products giving rise to an environmental pollution, such as PZT. Therefore, piezoelectric ceramics not containing lead in the composition and having piezoelectric properties equal to those of PZT are in demand.

As for the lead-free piezoelectric ceramic containing no lead, for example, those comprising BaTiO₃ are known. The piezoelectric ceramic comprising BaTiO₃ can exhibit relatively good piezoelectric properties and is being used in sonars and the like, but its piezoelectric properties are very low as compared with PZT and have only unsatisfactly low performance.

In order to improve the piezoelectric properties of the lead-free piezoelectric ceramic, various techniques have been heretofore developed.

For example, Japanese Unexamined Patent Application (Kokai) No. 11-180769 discloses a piezoelectric ceramic material having a fundamental composition of (1−x)BNT−BaTiO₃ (wherein x=0.06 to 0.12) and containing from 0.5 to 1.5 wt % of a rare earth element oxide.

Japanese Unexamined Patent Application (Kokai) No. 2000-272962 discloses a piezoelectric ceramic composition represented by the formula: {Bi_{0.5}(Na₁₋ₓKₓ)_{0.5}}TiO₃ (wherein 0.2<x≦0.3), and a piezoelectric ceramic composition obtained by incorporating 2 wt % or less of an additive (e.g., Fe₂O₃, Cr₂O₃, MnO₂, NiO, Nb₂O₅) into the above-described composition.

Japanese Unexamined Patent Application (Kokai) No. 2000-281443 discloses a piezoelectric ceramic composition mainly comprising a tungsten bronze-type composite oxide represented by the formula: xNaNbO₃−yBaNb₂O₆−zBiNb₃O₉ (wherein x+y+z=1 and (x, y, z) are present in a predetermined region of a three-component composition diagram), and containing Bi at a ratio of 3 to 6 wt % in terms of metal based on the entire weight.

Japanese Unexamined Patent Application (Kokai) No. 2000-313664 discloses an alkali metal-containing niobium oxide-based piezoelectric ceramic composition obtained by adding a compound containing one or more elements selected from Cu, Li and Ta to a solid solution represented by the formula: K₁₋ₓNaₓNbO₃ (wherein x=from 0 to 0.8).

Japanese Unexamined Patent Application (Kokai) No. 2002-137966 discloses a piezoelectric ceramic represented by the compositional formula: (1−x)NaNbO₃+xMnTiO₃ (wherein 0.014≦x≦0.08), and a piezoelectric ceramic obtained by incorporating from 0.5 to 10 mol % of KNbO₃ or NaNbO₃ as a sub-component into the composition represented by the above-described compositional formula.

Japanese Unexamined Patent Application (Kokai) No. 2001-240471 discloses a piezoelectric ceramic composition comprising a main component represented by NaₓNbO₃ (wherein 0.95≦x≦1) and a sub-component represented by the compositional formula: A_{y}BO_{f} (wherein A is Bi and at least one member of K, Na and Li, B is at least one member of Li, Ti, Nb, Ta and Sb, 0.2≦y≦1.5 and f is arbitrary), wherein the sub-component content is 8 mol % or less and at least one element selected from primary transition metal elements from Sc of atomic number 21 to Zn of atomic number 30 is contained in an amount of 0.01 to 3 wt % in terms of the oxide.

Japanese Unexamined Patent Application (Kokai) No. 2003-300776 discloses a production method of a piezoelectric ceramic comprising, as the first element, Na, K and Li and, as the second element, a perovskite-type oxide containing Nb and Ta and a tungsten bronze-type oxide.

Japanese Unexamined Patent Application (Kokai) No. 2003-306379 discloses a piezoelectric ceramic comprising a perovskite-type oxide (Na_{1-x-y}KₓLi_{y})(Nb_{1-z}Ta_{z})O₃ and a pyrochlore-type oxide M₂(Nb_{1-w}Ta_{w})₂O₇ (wherein M is an element belonging to Group 2 of the long Periodic Table).

Japanese Unexamined Patent Application (Kokai) No. 2003-327472 discloses a piezoelectric ceramic comprising a perovskite-type oxide (Na_{1-x-y}KₓLi_{y})(Nb_{1-z}Ta_{z})O₃ (wherein 0.1≦x≦0.9 and 0<y≦0.2) and a tungsten bronze-type oxide M(Nb₁₋ᵥTaᵥ)₂O₆ (wherein M is an element belonging to Group 2 of the long Periodic Table).

Japanese Unexamined Patent Application (Kokai) No. 2003-342069 discloses a piezoelectric ceramic composition represented by the formula: {Liₓ(K_{1-y}Na_{y})₁₋ₓ}(Nb_{1-z}Sb_{z})O₃, wherein x, y and z are 0≦x≦0.2, 0≦y≦1.0 and 0≦z≦0.2 (provided that x=z=0 is excluded).

Japanese Unexamined Patent Application (Kokai) No. 2003-342071 discloses a piezoelectric ceramic composition represented by the formula: {Liₓ(K_{1-y}Na_{y})₁₋ₓ}(Nb_{1-z-n}Ta_{z}(Mn_{0.5}W_{0.5})ₙ)O₃, wherein x, y, z and n are 0≦x≦0.2, 0≦y≦1.0, 0≦z≦0.4 and 0≦n≦0.1.

Furthermore, Japanese Unexamined Patent Application (Kokai) No. 2004-7406 discloses a piezoelectric element comprising a piezoelectric ceramic, wherein the piezoelectric ceramic contains ceramic crystal grains having shape anisotropy and spontaneous polarization preferentially oriented in one plane.

As described in eleven patent publications, it is known that when various additives are added to a lead-free ferroelectric substance, the sinterability and piezoelectric properties are enhanced. However, the piezoelectric properties are not satisfactorily enhanced by only adding additives. The reason considered to be as follows. That is, when an isotropic perovskite-type compound is produced by a production process for normal ceramics, that is, a production process of using, as the starting material, a simple compound containing component elements and performing firing, forming and sintering, each crystal grain in the obtained sintered body is randomly oriented. Therefore, even in the case of a composition intrinsically having high piezoelectric properties and the like, the obtained sintered body in actual may be unsatisfactorilly low in the piezoelectric properties and the like.

The piezoelectric properties and the like of the isotropic perovskite-type compound are generally known to vary according to the direction of crystallographic axis. Therefore, when the crystallographic axis of giving high piezoelectric properties and the like can be oriented to a fixed direction, the anisotropy of piezoelectric properties and the like can be maximally utilized and this is expected to bring elevated characteristics of the piezoelectric ceramics. Actually, some single crystals comprising a lead-free ferroelectric material are known to exhibit excellent piezoelectric properties and the like.

However, the single crystal has a problem that the production cost is high. In addition, in the case of a single crystal of a solid solution having complicated composition, deviation of the composition readily occurs during the production and the produced single crystal is unsuitable as a practical material. Furthermore, the single crystal is poor in fracture toughness and can be hardly used under high stress and therefore, the range of its application is disadvantageously limited.

On the other hand, as disclosed in Japanese Unexamined Patent Publication (Kokai) No. 2004-7406, according to a method of orienting a specific crystal plane by using, as a reactive template, a plate-like powder having a predetermined composition, a grain oriented ceramic in which a specific crystal plane is oriented at a high degree of orientation can be easily and inexpensively produced.

However, in the method where a plate-like powder comprising Ba₆Ti₁₇O₄₀, Bi₄Ti₄O₁₂ or the like is used as a reactive template, the A-site element (Ba or Bi) and the B-site element (Ti) contained in the plate-like powder remain in the resultant grain oriented ceramic. Therefore, when this method is applied to an isotropic perovskite-type potassium sodium niobate exhibiting relatively good piezoelectric properties out of lead-free materials or to a solid solution thereof, a desired composition may not be realized and the piezoelectric properties and the like may be deteriorated by the inevitably contained A-site element and/or B-site element.

In this way, conventional piezoelectric materials are still unsatisfactorilly low in the piezoelectric properties as compared with lead-based piezoelectric materials such as PZT, and more improvements are required.

### DISCLOSURE OF THE INVENTION

The present invention has been made by taking account of these problems and an object of the present invention is to provide grain oriented ceramics capable of providing excellent piezoelectric properties, a production method thereof, and a piezoelectric material, a dielectric material, a thermoelectric conversion element and an ion conducting element each using the grain oriented ceramic.

[Means to Solve the Problems]

A first invention is a grain oriented ceramic comprising, as the main phase, an isotropic perovskite-type compound which is represented by formula (1): {Liₓ(K_{1-y}Na_{y})₁₋ₓ}(Nb_{1-z-w}Ta_{z}Sb_{w})O₃ in which x, y, z and w are in respective composition ranges of 0≦x≦0.2, 0≦y≦1, 0≦z≦0.4, 0≦w≦0.2 and x+z+w>0,
wherein
the main phase comprises a polycrystalline body containing from 0.0001 to 0.15 mol of any one or more additional element selected from metal elements, semimetal elements, transition metal elements, noble metal elements and alkaline earth metal elements belonging to Groups 2 to 15 of the Periodic Table, per mol of the compound represented by formula (1), and
a specific crystal plane of each crystal grain constituting the polycrystalline body is oriented (claim 1).

In the grain oriented ceramic of the present invention, the isotropic perovskite-type compound represented by formula (1): {Liₓ(K_{1-y}Na_{y})₁₋ₓ}(Nb_{1-z-w}Ta_{z}Sb_{w})O₃ is used as the main phase. The compound represented by formula (1) corresponds to an isotropic perovskite compound represented by the formula: ABO₃ wherein the A-site element is K, Na and/or Li and the B-site element is Nb, Sb and/or Ta. In other words, the compound represented by formula (1) is an isotropic perovskite-type potassium sodium niobate (KNaNbO₃) where some amount of the A-site elements is replaced by a predetermined amount of Li and some amount of the B-site element is replaced by a predetermined amount of Ta and/or Sb. Therefore, this piezoelectric ceramic composition can exhibit excellent piezoelectric properties as compared with those having a composition not containing Li, Ta, Sb and the like.

The main phase comprises a polycrystalline sintered body containing from 0.0001 to 0.15 mol of any one or more additional element selected from metal elements, semimetal elements, transition metal elements, noble metal elements and alkaline earth metal elements belonging to Groups 2 to 15 of the Periodic Table, per mol of the compound represented by formula (1).

Therefore, this grain oriented ceramic has more excellent piezoelectric properties such as piezoelectric d₃₁ constant, electromechanical coupling factor Kp and piezoelectric g₃₁ constant as compared with those having the same composition but not containing the above-described additional element.

In the above-described grain oriented ceramic, the additional element may be added by replacement to the compound represented by formula (1), or also may be externally added and present in the grain of the compound represented by formula (1) and/or at the grain boundary. Furthermore, the additional element may be incorporated as the additional simple element or as an oxide or compound containing the additional element.

In the above-described grain oriented ceramic, a specific crystal plane of each crystal grain constituting the polycrystalline body is oriented.

Therefore, this grain oriented ceramic exhibits more excellent piezoelectric properties such as piezoelectric d₃₁ constant, electromechanical coupling factor Kp and piezoelectric g₃₁ constant as compared with a non-oriented form having the same composition.

In this way, the grain oriented ceramic of the first invention is safe to the environment because of the absence of lead and, at the same time, can be used as a high-performance piezoelectric element by virtue of its excellent piezoelectric properties.

Furthermore, the above-described grain oriented ceramic is excellent also in the dielectric properties such as relative dielectric constant and dielectric loss, in addition to those piezoelectric properties, and therefore, this grain oriented ceramic can also be used as a high-performance dielectric element.

The second invention is a piezoelectric element comprising a piezoelectric material comprising the grain oriented ceramic of the first invention (claim 12). Because of this high performance, this grain oriented ceramic of the first and second inventions can also be used for this film without sintering process.

The piezoelectric element of the second invention comprises a piezoelectric material comprising the grain oriented ceramic of the first invention. Accordingly, this piezoelectric element can make use of the property of the above-described grain oriented ceramic that the piezoelectric properties are excellent, and therefore, can be used as a functional ceramic material over a wide range, for example, in sensors such as an acceleration sensor, a pyroelectric sensor, an ultrasonic sensor, an electric field sensor, a temperature sensor and gas sensor; energy conversion elements such as a thermoelectric converter and a piezoelectric transformer; low-loss actuators and low-loss resonators such as a piezoelectric actuator, an ultrasonic motor and a resonator; capacitors; and ion conductors.

The third invention is a dielectric element comprising a dielectric material comprising the grain oriented ceramic of the first invention (claim 13).

The dielectric element of the third invention comprises a dielectric material comprising the grain oriented ceramic of the first invention. Accordingly, this dielectric element can make use of the property of the above-described grain oriented ceramic that the relative dielectric constant and the dielectric loss are excellent, and therefore, can be used, for example, as a capacitor having a large electrostatic capacity.

The fourth invention is a thermoelectric conversion element comprising a thermoelectric conversion material comprising the grain oriented ceramic of the first invention (claim 14).

The fifth invention is an ion conducting element comprising an ion conducting material comprising the grain oriented ceramic of the first invention (claim 15).

The thermoelectric conversion element of the fourth invention and the ion conducting element of the fifth invention comprise a thermoelectric conversion material comprising the grain oriented ceramic of the first invention. Accordingly, these thermoelectric conversion element and ion conducting element can make use of the excellent piezoelectric properties of the above-described grain oriented ceramic and therefore, can realize high performance with a very small loss.

The sixth invention is a method for producing a grain oriented ceramic, comprising:
a mixing step of mixing (i) a first anisotropically shaped powder comprising orienting particles each having an orienting plane where a specific crystal plane is oriented, (ii) a first reaction raw material of reacting with the first anisotropically shaped powder to produce an isotropic perovskite-type compound represented by formula (1): {Liₓ(K_{1-y}Na_{y})₁₋ₓ}(Nb_{1-z-w}Ta_{z}Sb_{w})O₃ (wherein 0≦x≦0.2, 0≦y≦1, 0≦z≦0.4, 0≦w≦0.2 and x+z+w>0), and (iii) any one or more additional element selected from metal elements, semimetal elements, transition metal elements, noble metal elements and alkaline earth metal elements belonging to Groups 2 to 15 of the Periodic Table, thereby producing a raw material mixture,
a forming step of forming the raw material mixture such that the orienting plane of the first anisotropically shaped powder is oriented nearly in the same direction in the formed body, and
a heat-treating step of heating the formed body to react the first anisotropically shaped powder and the first reaction raw material and to thereby produce a polycrystalline body which comprises the isotropic perovskite-type compound represented by formula (1) and of which the crystal grains are oriented to show a textured structure,
wherein
in the mixing step, the additional element is added in an amount of 0.0001 to 0.15 mol per mol of the compound represented by formula (1), and
the orienting plane of the orienting particles has lattice matching with the specific plane oriented in the crystal grains constituting the polycrystalline body obtained in the heat-treating step (claim 16).

The production method of a grain oriented ceramic of the present invention comprises the above-described mixing step, forming step and heat-treating step.

In the mixing step, the first anisotropically shaped powder, the first reaction raw material and the additional element are mixed to produce a raw material mixture.

In the forming step, the raw material mixture obtained above is formed such that the specific crystal plane of the first anisotropically shaped powder is oriented to a specific direction in the formed body.

In the heat-treating step, the formed body obtained above is heated to make the first anisotropically shaped powder and the first reaction raw material react.

The orienting particles constituting the first anisotropically shaped powder have an orienting plane formed by oriented specific crystal plane, and the raw material mixture is formed such that the orienting plane of the orienting particles are oriented nearly in the same direction in the formed body. More specifically, in the forming step, the raw material mixed powder is formed, for example, by allowing a force to act on the first anisotropically shaped powder from one direction and, as a result, the first anisotropically shaped powder can be oriented in the formed body by the effect of shearing stress acting on the first anisotropically shaped powder. When this formed body is heated in the heat-treating step, the first anisotropically shaped powder and the first reaction raw material are reacted, whereby an anisotropically shaped crystalline body comprising an isotropic perovskite-type compound taking over the orientation direction of the first anisotropically shaped powder can be produced, and in turn, the compound represented by formula (1) in which a specific crystal plane is oriented can be produced.

In the production method of the present invention, lattice matching is present between the orienting plane in the first anisotropically shaped powder and the specific crystal plane of the compound represented by formula (1). Accordingly, the first anisotropically shaped powder functions as a template or a reactive template, and the orienting plane in the first anisotropically shaped powder is taken over as the specific crystal plane of the produced compound represented by formula (1). Therefore, the compound represented by formula (1) can be produced in the state that, as described above, a specific crystal plane is oriented in one direction.

In the heat-treating step, the compound represented by formula (1) is produced and at the same time, sintered, whereby the polycrystalline sintered body can be preferably produced. In this way, the above-described grain oriented ceramic can be obtained.

In the mixing step, the above-described additional element is added in the above-described specific amount together with the plate-like powder and the perovskite producing raw material. The additional element may be add ed by replacing any one or more element of Li, K, Na, Nb, Ta and Sb in the isotropic perovskite-type compound represented by formula (1) or may be externally added to the compound represented by formula (1) and be present at the grain boundary of the compound represented by formula (1).

In the thus-obtained grain oriented ceramic, the main phase is an isotropic perovskite-type compound in the composition range of formula (1): {Liₓ(K_{1-y}Na_{y})₁₋ₓ}(Nb_{1-z-w}Ta_{z}Sb_{w})O₃ (wherein 0≦x≦0.2, 0≦y≦1, 0≦z≦0.4, 0≦w≦0.2 and x+z+w>0). Also, the main phase comprises a polycrystalline body containing from 0.0001 to 0.15 mol of any one or more additional element selected from metal elements, semi-metal elements, transition metal elements, noble metal elements and alkaline earth metal elements belonging to Groups 2 to 15 of the Periodic Table, per mol of the compound represented by formula (1), and a specific crystal plane of each crystal grain constituting the polycrystalline body is oriented. That is, according to the sixth invention, the grain oriented ceramic of the first invention can be obtained.

The grain oriented ceramic obtained in the present invention contains Li, Ta and Sb each in a specific amount and further contains the above-described additional element. Therefore, this grain oriented ceramic is excellent in the piezoelectric properties (e.g., piezoelectric d₃₁ constant, electromechanical coupling factor Kp, piezoelectric g₃₁ constant) and dielectric properties as compared with piezoelectric ceramics comprising an isotropic perovskite-type compound not containing these elements. Furthermore, in the grain oriented ceramic, a specific crystal plane is oriented at a high degree of orientation. Therefore, this grain oriented ceramic is excellent in the piezoelectric properties and dielectric properties as compared with non-oriented piezoelectric ceramics having the same composition.

### BRIEF DESCRIPTION OF THE DRAWINGS

FIG. 1 is a diagram showing the results of X-ray diffraction for Sample E1 according to Test Example.

FIG. 2 is a diagram showing the results of X-ray diffraction for Sample E2 according to Test Example.

FIG. 3 is a diagram showing the results of X-ray diffraction for Sample E3 according to Test Example.

FIG. 4 is a diagram showing the results of X-ray diffraction for Sample E4 according to Test Example.

FIG. 5 is a diagram showing the results of X-ray diffraction for Sample E5 according to Test Example.

FIG. 6 is a diagram showing the results of X-ray diffraction for Sample E6 according to Test Example.

FIG. 7 is a diagram showing the results of X-ray diffraction for Sample E7 according to Test Example.

FIG. 8 is a diagram showing the results of X-ray diffraction for Sample E8 according to Test Example.

FIG. 9 is a diagram showing the results of X-ray diffraction for Sample E9 according to Test Example.

FIG. 10 is a diagram showing the results of X-ray diffraction for Sample E10 according to Test Example.

FIG. 11 is a diagram showing the results of X-ray diffraction for Sample C2 according to Test Example.

FIG. 12 is a diagram showing the relationship between dielectric loss tan δ and temperature for Sample E11 and Sample C13 according to Test Example.

### BEST MODES FOR CARRYING OUT THE INVENTION

Embodiments of the present invention are described below.

The above grain oriented ceramic comprises, as the main phase, an isotropic perovskite-type compound which is represented by formula (1): {(Liₓ(K_{1-y}Na_{y})₁₋ₓ}(Nb_{1-z-w}Ta_{z}Sb_{w})O₃ in which x, y, z and w are in respective composition ranges of 0≦x≦0.2, 0≦y≦1, 0≦z≦0.4, 0≦w≦0.2 and x+z+w>0.

The grain oriented ceramic has a fundamental composition comprising potassium sodium niobate (K_{1-y}Na_{y})NbO₃ which is one of isotropic perovskite compounds, where a part of the A-site elements (K and Na) are replaced by a predetermined amount of Li and/or a part of the B-site element (Nb) is replaced by a predetermined amount of Ta and/or Sb.

In formula (1): {Liₓ(K_{1-y}Na_{y})₁₋ₓ}(Nb_{1-z-w}Ta_{z}Sb_{w})O₃, if x>0.2, z>0.4, w>0.2 or x+z+w=0, the piezoelectric properties (e.g., piezoelectric d₃₁ constant) and the dielectric properties decrease and a grain oriented ceramic having desired properties may not be obtained.

In formula (1), x+z+w>0 means that it is sufficient if at least one element of Li, Ta and Sb is contained as the replacement element.

As described above, the grain oriented ceramic has a main phase comprising a perovskite-structure (ABO₃) compound. In the present invention, the A-site element in the perovskite structure (ABO₃) corresponds to K, Na and Li, and the B-site element corresponds to Nb, Ta and Sb. In the compositional formula of this perovskite structure, when the atoms constituting the A site and the atoms constituting the B site are at a stoichiometric ratio of 1:1, a complete perovskite structure is formed. However, in the case of the above-described grain oriented ceramic, K, Na, Li and Sb in particular may volatilize by several %, specifically, by about 3%, due to heating or the like during the production, or all constituent elements may change by several %, specifically, by about 3%, due to mixing/grinding, granulation or the like at the production. That is, deviation from the stoichiometric composition may occur due to fluctuation of the production process.

In order to cope with such fluctuation of the composition in the production process, the blending composition may be intentionally changed so that the compositional ratio of the grain oriented ceramic after heating (firing) can change within ±several %, specifically, on the order of ±3 to 5%. The same applies also in the case of conventional ceramics using, for example, zirconium titanate (PZT), and the blending ratio can be adjusted by taking account of the evaporation of lead at firing or the mingling of zirconia from zirconia ball which is a grinding medium.

In the above-described grain oriented ceramic, even when the blending compositional ratio is intentionally changed as above, the electrical properties such as piezoelectric properties are not greatly changed.

Accordingly, in the present invention, the compound represented by formula (1): {Liₓ(K_{1-y}Na_{y})₁₋ₓ}(Nb_{1-z-w}Ta_{z}Sb_{w})O₃ may have a constitutional ratio such that when this compound is applied to the perovskite-structure compositional formula ABO₃, the A-site element and the B-site element each deviates within about ±5 mol % from the constitutional ratio of 1:1. Incidentally, in order to decrease the lattice defects in the crystal constructed and obtain high electrical properties, a composition having a deviation up to about ±3% is preferred.

That is, the compound represented by formula (1) as the main phase of the grain oriented ceramic includes a range of [Liₓ(K_{1-y}Na_{y})₁₋ₓ]ₐ{(Nb_{1-z-w}Ta_{z}Sb_{w})}_{b}O₃ (wherein 0≦x≦0.2, 0≦y≦1, 0≦z≦0.4, 0≦w≦0.2, x+z+w>0, 0.95≦a≦1.05 and 0.95≦b≦1.05). Also, as described above, a and b are preferably 0.97≦a≦1.03 and 0.97≦b≦1.03.

In formula (1), x is preferably 0<x≦0.2.

In this case, the compound represented by formula (1) comprises Li as an essential component and, therefore, the grain oriented ceramic can be more easily fired at the production and can have more enhanced piezoelectric properties and a higher Curie temperature (Tc). This is because when Li is contained as an essential component in the above-described range of x, the firing temperature decreases and at the same time, Li serves as a firing aid and, as a result, firing with fewer pores can be achieved.

Also, in formula (1), x may be x=0.

In this case, formula (1) is represented by (K_{1-y}Na_{y})(Nb_{1-z-w}Ta_{z}Sb_{w})O₃ and since a compound comprising most lightweight Li, such as LiCO₃, is not contained in the raw materials at the production of the grain oriented ceramic, the fluctuation of properties due to segregation of the raw material powder can be decreased when the grain oriented ceramic is produced by mixing the raw materials.

In formula (1), y is preferably 0<y≦1.

In this case, the compound represented by formula (1) comprises Na as an essential component and therefore, the piezoelectric g₃₁ constant of the grain oriented ceramic can be more enhanced.

Also, in formula (1), y may be 0≦y<1.

In this case, the compound represented by formula (1) comprises K as an essential component and therefore, the piezoelectric properties such as piezoelectric d₃₁ constant of the grain oriented ceramic can be more enhanced. Furthermore, in this case, as the amount of K added is increased, the sintering can be performed at a lower temperature, so that the grain oriented ceramic can be produced in an energy-saving manner and at a low cost.

In formula (1), y may be y=0.

In this case, formula (1) is represented by (LiₓK₁₋ₓ)(Nb_{1-z-w}Ta_{z}Sb_{w})O₃ and since Na is not contained in the compound represented by formula (1), the grain oriented ceramic can be enhanced in view of dielectric loss.

Also, in formula (1), y may be y=1.

In this case, formula (1) is represented by (LiₓNa₁₋ₓ)(Nb_{1-z-w}Ta_{z}Sb_{w})O₃ and since K is not contained in the compound represented by formula (1), K₂CO₃ or the like having deliquescency need not be used as a raw material at the production of the compound. Furthermore, the handling of synthesis raw materials and the adjustment of components of the compound can be facilitated, because a K component readily sublimable during heat treatment is not contained.

In formula (1): {Liₓ(K_{1-y}Na_{y})₁₋ₓ}(Nb_{1-z-w}Ta_{z}Sb_{w})O₃, y is more preferably 0.05≦y≦0.75, still more preferably 0.20≦y≦0.70. In these cases, the piezoelectric d₃₁ constant and electromechanical coupling factor Kp can be more enhanced. Furthermore, 0.20≦y<0.70 is preferred, 0.35≦y≦0.65 is more preferred, 0.35≦y<0.65 is still more preferred, and 0.42≦y≦0.60 is most preferred.

In formula (1), z is preferably 0<z≦0.4.

In this case, the compound represented by formula (1) comprises Ta as an essential component and, therefore, the sintering temperature lowers and at the same time, Ta serves as a sintering aid, as a result, pores in the grain oriented ceramic can be decreased.

In formula (1), z may be z=0.

In this case, formula (1) is represented by {Liₓ(K_{1-y}Na_{y})₁₋ₓ}(Nb_{1-w}Sb_{w})O₃ and since Ta is not contained in the compound represented by formula (1), excellent piezoelectric properties can be obtained without using an expensive Ta component at the production of the compound represented by formula (1).

Also, in formula (1), w is preferably 0<w≦0.2.

In this case, the compound represented by formula (1) comprises Sb as an essential component and therefore, the sintering temperature lowers, as a result, the sinterability and the stability of dielectric loss tan δ can be enhanced.

In formula (1), w may be w=0.

In this case, formula (1) is represented by {Liₓ(K_{1-y}Na_{y})₁₋ₓ}(Nb_{1-z}Ta_{z})O₃ and since Sb is not contained in the compound represented by formula (1), the compound can exhibit a relatively high Curie temperature.

In the above-described grain oriented ceramic, the main phase is an isotropic perovskite-type compound represented by formula (1). The term “main phase” as used herein means that the ratio of the compound represented by formula (1) occupying in the entire grain oriented ceramic is 90 vol % or more. As for the remaining component of less than 10 vol %, other phases may be contained as long as the isotropic perovskite-type crystal structure can be maintained and various properties such as sintering properties and piezoelectric properties are not adversely affected. Examples of the “other phases” include additives, sintering aid, by-products and impurities (e.g., Bi₂O₃, CuO, MnO₂, NiO), which are attributable to the production method described later or the raw materials used.

The above-described main phase comprises a polycrystalline body containing from 0.0001 to 0.15 mol of any one or more additional element selected from metal elements, semimetal elements, transition metal elements, noble metal elements and alkaline earth metal elements belonging to Groups 2 to 15 of the Periodic Table, per mol of the compound represented by formula (1).

If the additional element content is less than 0.0001 mol or exceeds 0.15 mol, the piezoelectric properties or dielectric properties of the grain oriented ceramic may decrease.

The additional element content is preferably from 0.0001 to 0.05 mol, more preferably from 0.0001 to 0.02 mol, still more preferably from 0.0005 to 0.02 mol, per mol of the compound represented by formula (1).

The additional element may take a form that the additional element is arranged by replacing at least a part of Li, K, Na, Nb, Ta and Sb in the compound represented by formula (1): {Liₓ(K_{1-y}Na_{y})₁₋ₓ}(Nb_{1-z-w}Ta_{z}Sb_{w})O₃. For example, the element capable of becoming +2-valent, such as Mg, Ca, Sr and Ba, tends to be arranged to replace at least a part of Li, K and Na in the compound represented by formula (1). The element capable of becoming +1 or +2-valent, such as Cu, Ni, Fe and Zn, also tends to be arranged to replace at least a part of Li, K and Na in the compound represented by formula (1). On the other hand, the element capable of becoming +3 to +6-valent, such as Fe and Mn, tends to be arranged to replace at least a part of Na, Ta and Sb in the compound represented by the above-described formula. In this way, the additional element takes a form of substitution solid solution in the grain oriented ceramic, whereby properties such as the piezoelectric d₃₁ constant can be more enhanced.

The additional element may also take a form that the additional simple element or an oxide or compound (e.g., perovskite-type compound) containing the additional element is present, for example, in the grain or at the grain boundary of the grain oriented ceramic.

The additional element is preferably contained in the crystal grain constituting the polycrystalline body and/or at the grain boundary (claim 2). That is, the additional element is preferably externally added to the compound represented by formula (1).

In this case, the additional element can be easily and simply added to the compound represented by formula (1). Furthermore, by precipitating the additional simple element or a compound containing the additional element in the crystal grain or at the grain boundary, a dispersion strengthening mechanism is exerted and the strength or toughness of the ceramic can be enhanced.

The additional element is preferably added at a ratio of 0.01 to 15 atm % by replacing any one or more element selected from Li, K, Na, Nb, Ta and Sb in the isotropic perovskite-type compound represented by formula (1) (claim 3).

In this case, the piezoelectric properties (e.g., piezoelectric d₃₁ constant, electromechanical coupling factor Kp) and dielectric properties (e.g., relative dielectric constant ε_{33T}/ε₀) of the grain oriented ceramic can be more enhanced.

If the additional element content is less than 0.01 atm % or exceeds 15 atm %, the piezoelectric properties or dielectric properties of the grain oriented ceramic may decrease.

The additional element content is preferably from 0.01 to 5 atm %, more preferably from 0.01 to 2 atm %, still more preferably from 0.05 to 2 atm %, based on the any one or more element selected from Li, K, Na, Nb, Ta and Sb in the isotropic perovskite-type compound represented by formula (1).

The “atm %” as used herein means a percentage ratio of the number of replaced atoms to the number of atoms of Li, K, Na, Nb, Ta and Sb in the compound represented by formula (1).

The additional element is preferably any one or more element selected from Mg, Ca, Sr and Ba (claim 4).

In this case, the additional element can easily replace at least a part of K and/or Na in the compound represented by formula (1) and therefore, the compound represented by formula (1) can be a compound represented by formula (3): {Liₓ(K_{1-y}Na_{y})₁₋ₓ₋₂ᵤMaᵤ}(Nb_{1-z-w}Ta_{z}Sb_{w})O₃ (wherein Ma is at least one or more metal element selected from Mg, Ca, Sr and Ba, and x, y, z, w and u are 0≦x≦0.2, 0≦y≦1, 0≦z≦0.4, 0≦w≦0.2, x+z+w>0, and 0.0001≦u≦0.15), as a result, the piezoelectric properties (e.g., piezoelectric d₃₁ constant, electromechanical coupling factor Kp) and dielectric properties (e.g., relative dielectric constant ε_{33T}/ε₀) of the grain oriented ceramic can be more enhanced.

Also, the additional element is preferably any one or more element selected from Sc, Ti, V, Cr, Mn, Fe, Co, Ni, Cu, Zn, Y, Zr, Mo, Hf, W and Re (claim 5).

In this case, the piezoelectric properties such as the mechanical quality factor Qm, the piezoelectric d₃₁ constant and the dielectric loss tan δ of the grain oriented ceramic can be more enhanced.

The additional element is preferably any one or more element selected from Pd, Ag, Ru, Rh, Pt, Au, Ir and Os (claim 6).

In this case, the piezoelectric properties (e.g., piezoelectric d₃₁ constant, piezoelectric g₃₁ constant, electromechanical coupling factor Kp) and dielectric properties (e.g., relative dielectric constant ε_{33T}/ε₀, dielectric loss tan δ) of the grain oriented ceramic can be more enhanced.

Also, the additional element is preferably any one or more element selected from B, Al, Ga, In, Si, Ge, Sn and Bi (claim 7).

In this case, the additional element serves as a sintering aid and accelerates densification of the grain oriented ceramic and therefore, the grain oriented ceramic can be easily sintered. As a result, the grain oriented ceramic has good quality with a high apparent density and less pores and in turn ensures excellent mechanical strength.

In the grain oriented ceramic, a specific crystal plane of each crystal grain constituting the above-described polycrystalline body is oriented.

The term “a specific crystal plane is oriented” means that each crystal grain is aligned to cause specific crystal planes of the compounds represented by formula (1) to run parallel with each other (hereinafter, this state is referred to as “plane orientation”) or each crystal grain is oriented to cause specific crystal planes to run parallel with one axis penetrating the formed body (hereinafter, this state is referred to as “axis orientation”).

The kind of the oriented crystal plane is not particularly limited and is selected according to the direction of spontaneous polarization of the compound represented by formula (1), the usage of grain oriented ceramic, the required properties and the like. That is, the oriented crystal plane is selected from pseudo-cubic {100} plane, pseudo-cubic {110} plane, pseudo-cubic {111} plane, and the like, according to the purpose.

The “pseudo-cubic {HKL}” means that although the isotropic perovskite-type compound generally takes a structure slightly distorted from a cubic crystal, such as tetragonal crystal, orthorhombic crystal or trigonal crystal, the distortion is slight and therefore, the structure is regarded as a cubic crystal and expressed by the mirror index.

In the case where a specific crystal plane is plane-oriented, the degree of plane orientation can be expressed by an average orientation degree F(HKL) according to the Lotgering's method represented by the following mathematical formula 1:

$$F ( HKL ) = \frac{\frac{{Σ}^{′} I ( HKL )}{Σ I ( hkl )} - \frac{{Σ}^{′} {I}_{0} ( HKL )}{Σ {I}_{0} ( hkl )}}{1 - \frac{{Σ}^{′} {I}_{0} ( HKL )}{Σ {I}_{0} ( hkl )}} \times 100 ( \% ) \qquad ( Mathematical Formula 1 )$$

In mathematical formula 1, ΣI(hkl) is a sum total of X-ray diffraction intensities of all crystal planes (hkl) measured for the grain oriented ceramic, ΣI₀(hkl) is a sum total of X-ray diffraction intensities of all crystal planes (hkl) measured for a non-oriented piezoelectric ceramic having the same composition as the grain oriented ceramic, Σ′I(HKL) is a sum total of X-ray diffraction intensities of crystallographically equivalent specific crystal planes (HKL) measured for the grain oriented ceramic, and Σ′I₀(HKL) is a sum total of X-ray diffraction intensities of crystallographically equivalent specific crystal planes (HKL) measured for a non-oriented ceramic having the same composition as the grain oriented ceramic.

Accordingly, when each crystal grain constituting the polycrystalline body is non-oriented, the average orientation degree F(HKL) becomes 0%, whereas when the (HKL) plane of all crystal grains constituting the polycrystalline body is oriented in parallel with the measurement plane, the average orientation degree F(HKL) becomes 100%.

In the grain oriented ceramic, as the ratio of oriented crystal grains is larger, better properties are obtained. For example, in the case of plane-orienting a specific crystal plane, the average orientation degree F(HKL) as measured according to the Lotgering's method represented by mathematical formula 1 is preferably 30% or more so as to obtain better piezoelectric properties or the like (claim 8). The average orientation degree is more preferably 50% or more. The specific crystal plane to be oriented is preferably a plane perpendicular to the polarization axis. In the case where the crystal type of the perovskite-type compound is a tetragonal crystal, the specific crystal plane to be oriented is preferably a {100} plane.

In the case of axis-orienting a specific crystal plane, the orientation degree cannot be defined by the same orientation degree (mathematical formula 1) as the plane orientation, but the degree of axis orientation can be expressed by using an average orientation degree according to the Lotgering's method for the (HKL) diffraction when X-ray diffraction is performed on the plane perpendicular to the orientation axis (hereinafter, referred to as an “axis orientation degree”). The axis orientation degree of a formed body where a specific crystal plane is almost completely axis-oriented becomes nearly the same as the axis orientation degree measured for a formed body where a specific crystal plane is almost completely plane-oriented.

The grain oriented ceramic preferably has a piezoelectric d₃₁ constant 1.1 times or more that of a non-oriented ceramic which comprises a polycrystalline body having the same composition as the grain oriented ceramic and in which the crystal plane of the grain constituting the polycrystalline body is not oriented or the crystal grains are not oriented to show a textured structure (claim 9).

The grain oriented ceramic preferably has an electromechanical coupling factor Kp 1.1 times or more that of a non-oriented ceramic which comprises a polycrystalline body having the same composition as the grain oriented ceramic and in which the crystal plane of the grain constituting the polycrystalline body is not oriented or the crystal grains are not oriented to show a textured structure (claim 10).

The grain oriented ceramic preferably has a piezoelectric g₃₁ constant 1.1 times or more that of a non-oriented ceramic which comprises a polycrystalline body having the same composition as the grain oriented ceramic and in which the crystal plane of the grain constituting the polycrystalline body is not oriented or the crystal grains are not oriented to show a textured structure (claim 11).

When the piezoelectric g₃₁ constant, electromechanical coupling factor Kp and piezoelectric g₃₁ constant of the grain oriented ceramic each is 1.1 times or more that of the non-oriented ceramic, the effect obtained by orienting the specific crystal plane can be fully exerted. Therefore, in this case, application to a piezoelectric element such as a piezoelectric actuator, a piezoelectric filter, a piezoelectric oscillator, a piezoelectric transducer, a piezoelectric ultrasonic motor, a piezoelectric gyro sensor, a knock sensor, a yaw rate sensor, an air bag sensor, a back sonar, a corner sonar, a piezoelectric buzzer, a piezoelectric speaker and a piezoelectric firing device is facilitated.

In the grain oriented ceramic of the present invention, the piezoelectric d₃₁ constant, electromechanical coupling factor Kp and piezoelectric g₃₁ constant each can be made to be 1.1 times or more that of the non-oriented ceramic by optimizing the composition, orientation degree, production conditions and the like of the compound represented by formula (1). By performing further optimization, the piezoelectric d₃₁ constant, electromechanical coupling factor Kp and piezoelectric g₃₁ constant each can be made to be 1.2 times or more, or 1.3 times or more.

In the material for actuators, a displacement generated in the direction parallel to the voltage applying direction under a large electric field with an electric field intensity of 100 V/mm or more is utilized. In using the above-described grain oriented ceramic as a material for actuators, the displacement generated under a large electric field in the conditions of the same temperature and the same electric field intensity can be made to be at least 1.1 times or more that of the non-oriented ceramic having the same composition by optimizing the composition, orientation degree, production conditions or the like of the compound represented by formula (1) constituting the main phase. A grain oriented ceramic capable of exhibiting a displacement 1.2 times or more that of the non-oriented ceramic can be obtained by further optimizing these conditions, and the displacement can be made to be 1.3 times or more that of the non-oriented ceramic by still further optimizing these conditions.

Also, the material for actuators is demanded to have a small temperature dependency of the displacement generated under a large electric field. The non-oriented ceramic has a large temperature dependency of the displacement generated and is not suited for use in actuators. On the other hand, in the grain oriented ceramic of the present invention, excellent temperature properties having a temperature region where the fluctuation width from the average of maximum value and minimum value of the displacement generated under a large electric field is at least within ±20% over an arbitrary temperature range of 100° C. or more can be obtained by optimizing the composition, orientation degree, production conditions and the like of the compound represented by the above-described formula constituting the main phase. Furthermore, a grain oriented ceramic having a temperature region where the fluctuation width from the average value of maximum displacement and minimum displacement in an arbitrary temperature range of 100° C. or more is at least within 10% can be obtained by further optimizing these conditions, and the fluctuation width can be made to be within 7% by still further optimizing these conditions, and within 5% by yet still further optimizing these conditions. Incidentally, in order to obtain a large amount of displacement, the electric field intensity during driving is preferably 500 V/mm or more, more preferably 1,000 V/mm or more.

The system for controlling the displacement generated under a large electric field can be classified into (a) a voltage control method of controlling the displacement by using a voltage as a parameter, (b) an energy control method of controlling the displacement by using the injected energy as a parameter, and (c) an electric charge control method of controlling the displacement by using the injected electric charge as a parameter.

In the case of (a) the voltage control method, the temperature dependency of the generated displacement with a constant voltage is preferably small.

In the case of (b) the energy control method, the temperature dependency of the generated displacement with a constant injected energy is preferably small.

In the case of (c) the electric charge control method, the temperature dependency of the generated displacement with a constant injected electric charge is preferably small.

In the case of energy control and electric charge control, the terminal voltage loaded to the actuator and driving circuit fluctuates due to temperature dependency of the electrostatic capacity under a large electric field and therefore, the circuit must be designed based on the upper limit of the fluctuation width of terminal voltage. Depending on the temperature dependency of the electrostatic capacity, an expensive circuit element with high breakdown voltage may be required. Therefore, the temperature property of the electrostatic capacity is preferably small. These can be easily understood from the following formulae A3 and A4:
W=½×C×V² A3
Q=C×V A4
wherein W: energy (J), C: electrostatic capacity (F), V: applied voltage (V) and Q: electric charge (C).

Furthermore, the displacement (amount of electric field induced displacement, ΔL) of actuator is proportional to the applied voltage and therefore, the displacement at constant electric field driving (EF, constant) is proportional to D_{33large} as understood from the following formula A5:
ΔL=D_{33large}×EFₘₐₓ×L A5
wherein D_{33large}: dynamic strain (m/V), EFₘₐₓ: maximum electric field intensity (V/m) and L: original length (m) before applying voltage. D_{33large} is a displacement generated in the direction parallel to the voltage applying direction when a high voltage with an electric field intensity of 0 to 2,000 V/mm is applied at a constant amplitude, and determined as a dynamic strain according to the following formula A6:
D_{33large}=Sₘₐₓ/EFₘₐₓ=(ΔL/L)/(V/L) A6

The displacement (ΔL) at low energy driving (W, constant) is proportional to D_{33large}/(E_{33large})^{1/2} as understood from the following formulae A7 and A8:
ΔL=D_{33large}×(2×W/C)^{1/2} A7
C=E_{33large}×ε₀×A/L A8
wherein ΔL: amount (m) of electric field induced displacement, E_{33large}: dynamic dielectric constant, A: electrode area (m²) and ε₀: dielectric constant (F/m) in vacuum.

E_{33large} is determined as follows. The amount of polarization when the actuator is driven by applying a high voltage with an electric field intensity of 0 to 2,000 V/mm at a constant amplitude is measured according to the following formula A9 from a polarization-electric field hysteresis loop and based on the measured value, the amount of electric charge injected at the driving in a high electric field is calculated as the relative dielectric constant (dynamic dielectric constant).
E_{33large}=Pₘₐₓ/(EFₘₐₓ×ε₀)=(Qₘₐₓ/A)/((V/L)×ε₀) A9
wherein Pₘₐₓ: maximum electric charge density (C/m²) and Qₘₐₓ: maximum electric charge (C).

Furthermore, the displacement (amount of electric field induced displacement: ΔL) at constant electric charge driving (Q, constant) is proportional to D_{33large}/E_{33large} as understood from the following formula A10 and formula A8:
ΔL=D_{33large}×Q/C A10

The non-oriented ceramic is not suited for use in actuators, because the temperature dependency of D_{33large} and E_{33large} is large and the temperature dependency of D_{33large}/(E_{33large})^{1/2} and D_{33large}/E_{33large} is also large.

On the other hand, in the grain oriented ceramic of the present invention, excellent temperature properties having a temperature region where, out of D_{33large}/(E_{33large})^{1/2}, D_{33large}/E_{33large} and E_{33large} generated under a large electric field, any one or more fluctuation width from the average of maximum value and minimum value is at least within ±20% over an arbitrary temperature range of 100° C. or more can be obtained by optimizing the composition, orientation degree, production conditions and the like of the compound represented by formula (1) constituting the main phase.

When these conditions are further optimized, a grain oriented ceramic having a temperature region where the fluctuation width from the average of maximum displacement and minimum displacement in an arbitrary temperature range of 100° C. or more is within ±15% can be obtained. The fluctuation width can be made to be within ±10% by more optimizing the conditions, within 8% by still more optimizing the conditions, and within 5% by yet still more optimizing the conditions.

The ceramic having a complicated composition, as in the compound represented by formula (1), is usually produced by a method where simple compounds containing component elements are mixed to give a stoichiometric ratio, the resultant mixture is formed, fired and ground, and the ground powder is reformed and sintered. However, the above-described grain oriented ceramic in which a specific crystal plane of each crystal grain is oriented in a specific direction can be hardly produced by such a method.

In the sixth invention (claim 16), as described above, a first anisotropically shaped powder satisfying specific conditions is oriented in the formed body and the compound represented by formula (1) is synthesized and sintered by using the first anisotropically shaped powder as a template or a reactive template, whereby a specific crystal plane of each crystal grain constituting the polycrystalline body is oriented in one direction.

The first anisotropically shaped powder is described below.

The first anisotropically shaped powder comprises orienting particles (aligning particles) having an orienting plane where a specific crystal plane is oriented (or an orienting plane (an aligning plane) formed by oriented specific crystal plane).

The orienting particles (aligning particles) preferably have a shape that facilitates orientation (alignment) in a fixed direction at the forming step described later. For this purpose, the orienting particles (aligning particles) preferably have an average aspect ratio of 3 or more. If the average aspect is less than 3, the first anisotropically shaped powder can be hardly oriented (aligned) in one direction at the forming step described later. In order to obtain a grain oriented ceramic having a higher orientation degree, the aspect ratio of the orienting particles (aligning particles) is preferably 5 or more. The average aspect ratio is an average value of maximum dimension and minimum dimension of the orienting particles.

As the average aspect ratio of the orienting particles is larger, the orienting particles tend to be more easily oriented in the forming step described later. However, if the average aspect ratio is excessively large, the orienting particles may be broken at the mixing step and in turn, a formed body where the orienting particles are oriented may not be obtained in the forming step. Accordingly, the average aspect ratio of the orienting particles is preferably 100 or less.

The average particle diameter (average value of the dimension in the longitudinal direction) of the orienting particles is preferably 0.05 μm or more. If the average particle diameter is less than 0.05 μm, the orienting particles can be hardly oriented in a fixed direction, for example, by a shearing stress in the forming step. Furthermore, the gain of interfacial energy becomes small and when the orienting particles are used as a reactive template for the production of the grain oriented ceramic, epitaxial growth on the template particles may not be easily proceed.

The average grain diameter of the orienting particles is preferably 20 μm or less. If the average particle diameter of the orienting particles exceeds 20 μm, the sinterability decreases and a grain oriented ceramic having a high sintered body density may not be obtained.

The average particle diameter of the orienting particles is more preferably from 0.1 to 10 μm.

The orienting plane of the orienting particles has lattice matching with a certain plane oriented in the crystal grains constituting the polycrystalline body obtained at the heat-treating step.

If the orienting plane has no lattice matching with the certain plane oriented in the crystal grains, the orienting particles may not function as a reactive template for the production of the grain oriented ceramic.

In the orienting particles, the orienting plane is preferably a developed plane which is a plane occupying the largest area in the orienting particles.

In this case, the orienting particles can be a more excellent reactive template for the production of the grain oriented ceramic.

Whether the lattice matching is good or bad can be expressed by a value obtained by dividing an absolute value of the difference between the lattice size of the orienting plane in the orienting particles and the lattice size of the specific crystal plane oriented in the compound represented by formula (1), by the lattice size of the orienting plane in the orienting particles (hereinafter, this value is referred to as a “lattice matching ratio”). The lattice matching ratio may vary slightly depending on the direction of the lattice used. Generally, as the average lattice matching ratio (average value of the lattice matching ratio calculated for each direction) is smaller, this reveals that the orienting particles function as a better template. In order to obtain a grain oriented ceramic having a high orientation degree, the average lattice matching ratio of the orienting particles is preferably 20% or less, more preferably 10% or less.

The orienting particles are not necessarily required to have the same composition as the compound represented by formula (1) and may be sufficient if it reacts with a first reaction raw material described later to produce the objective compound represented by formula (1). Accordingly, the orienting particles can be selected from compounds or solid solutions containing one or more element out of cation elements contained in the compound represented by formula (1), which it is intended to produce.

The “anisotropically shaped” as used herein means that the dimension in the longitudinal direction is large as compared with the dimension in the width or thickness direction. Specific preferred examples of the shape include plate, column, flake and needle. The crystal plane constituting the orienting plane is not particularly limited in its kind and may be selected from various crystal planes according to the purpose.

As for the first anisotropically shaped powder comprising a orienting particle satisfying the above-described conditions, for example, those comprising a compound represented by the following formula (2) which is a kind of perovskite-type compound, such as NaNbO₃ (hereinafter, referred to as “NN”), KNbO₃ (hereinafter, referred to as “KN”) or K_{1-y}Na_{y}NbO₃ (0<y<1) or a compound resulting from replacement-solid dissolution of a predetermined amount of Li, Ta and/or Sb in these compounds, can be used.
{Liₓ(K_{1-y}Na_{y})₁₋ₓ}(Nb_{1-z-w}Ta_{z}Sb_{w})O₃ (2)
(wherein x, y, z and w are 0≦x≦1, 0≦y≦1, 0≦z≦1 and 0≦w≦1).

The compound represented by formula (2) of course has good lattice matching with the compound represented by formula (1). Therefore, the anisotropically shaped powder comprising the orienting particles represented by formula (2) with a specific crystal plane being the orienting plane (hereinafter, this powder is particularly referred to as an “anisotropically shaped powder A”) functions as a reactive template for the production of the grain oriented ceramic. Furthermore, the anisotropically shaped powder A is substantially constituted by cation elements contained in the compound represented by formula (1) and therefore, a grain oriented ceramic remarkably reduced in impurity elements can be produced. Among these particles, preferred as the orienting particles are plate-like particles comprising the compound represented by formula (2) and using a pseudo-cubic {100} plane as the orienting plane, and more preferred are plate-like particles comprising NN or KN and using a pseudo-cubic {100} plane as the orienting plane.

The first anisotropically shaped powder preferably an anisotropically shaped powder which comprises a layered perovskite-type compound and in which a crystal plane having a small surface energy has lattice matching with the above-described certain plane of the compound represented by formula (1). The layered perovskite-type compound has a large crystal lattice anisotropy and therefore, an anisotropically shaped powder with the orienting plane being a crystal plane having a small surface energy (hereinafter, this powder is particularly referred to as a “second anisotropically shaped powder”) can be relatively easily synthesized.

A first example of the layered perovskite-type compound suitable as a material of the second anisotropically shaped powder includes a bismuth layered perovskite-type compound represented by the following formula (4):
(Bi₂O₂)²⁺(Bi_{0.5}AM_{m-1.5}NbₘO₃ₘ₊₁)²⁻ (4)
wherein m is an integer of 2 or more, and AM is at least one alkali metal element selected from Li, K and Na.

The compound represented by formula (4) is characterized in that the surface energy of the {001} plane is lower than the surface energy of other crystal planes, and therefore, the second anisotropically shaped powder with the orienting plane being a {001} plane can be easily synthesized by using the compound represented by formula (4). The “{001} plane” as used herein is a plane parallel to the (Bi₂O₂)²⁺ layer of the bismuth layered perovskite-type compound. Moreover, the {001} plane of the compound represented by formula (4) has very excellent lattice matching with the pseudo-cubic {100} plane of the compound represented by formula (1).

Therefore, the second anisotropically shaped powder comprising the compound represented by formula (4) and using the {001} plane as the orienting plane is suitable as a reactive template for the production of a grain oriented ceramic with the orienting plane being a {100} plane. Furthermore, when the compound represented by formula (4) is used and the composition of a first reaction raw material described later is optimized, a grain oriented ceramic comprising the compound represented by formula (4) as the main phase and containing substantially no Bi as the A-site element can be produced.

A second example of the layered perovskite-type compound suitable as a material of the second anisotropically shaped powder includes Sr₂Nb₂O₇. The {010} plane of Sr₂Nb₂O₇ has a surface energy lower than the surface energy of other crystal planes and has very excellent lattice matching with the pseudo-cubic {110} plane of the compound represented by formula (1). Therefore, an anisotropically shaped powder comprising Sr₂Nb₂O₇ and using the {010} plane as the orienting plane is suitable as a reactive template for the production of a grain oriented ceramic with the orienting plane being a {110} plane.

A third example of the layered perovskite-type compound suitable as a material of the second anisotropically shaped powder includes Na_{1.5}Bi_{2.5}Nb₃O₁₂, Na_{2.5}Bi_{2.5}Nb₄O₁₅, Bi₃TiNbO₉, Bi₃TiTaO₉, K_{0.5}Bi_{2.5}Nb₂O₉, CaBi₂Nb₂O₉, SrBi₂Nb₂O₉, BaBi₂Nb₂O₉, BaBi₃Ti₂NbO₁₂, CaBi₂Ta₂O₉, SrBi₂Ta₂O₉, BaBi₂Ta₂O₉, Na_{0.5}Bi_{2.5}Ta₂O₉, Bi₇Ti₄NbO₂₁ and Bi₅Nb₃O₁₅. The {001} plane of these compounds has good lattice matching with the pseudo-cubic {100} plane of the compound represented by formula (1) and therefore, an anisotropically shaped powder comprising such a compound and using the {001} plane as the orienting plane is suitable as a reactive template for the production of a grain oriented ceramic with the orienting plane being a {100} plane.

A fourth example of the layered perovskite-type compound suitable as a material of the second anisotropically shaped powder includes Ca₂Nb₂O₇ and Sr₂Ta₂O₇. The {010} plane of these compounds have good lattice matching with the pseudo-cubic {110} plane of the compound represented by formula (1) and therefore, an anisotropically shaped powder comprising such a compound and using the {010} plane as the orienting plane is suitable as a reactive template for the production of a grain oriented ceramic with the orienting plane being a {110} plane.

The production method of the first anisotropically shaped powder is described below. The first anisotropically shaped powder comprising a layered perovskite-type compound having predetermined composition, average particle diameter and/or aspect ratio (that is, the second anisotropically shaped powder) can be easily produced by using an oxide, carbonate, nitrate or the like containing the component elements as the raw material (hereinafter, referred to as an “anisotropically shaped powder-producing raw material”) and heating the anisotropically shaped powder-producing raw material together with a liquid or a substance which becomes a liquid under heat.

When the anisotropically shaped powder-producing raw material is heated in a liquid phase allowing for easy diffusion of atoms, the second anisotropically shaped powder in which a plane having a small surface energy (for example, the {1001} plane in the case of the compound represented by formula (4)) is preferentially grown can be easily synthesized. In this case, the average aspect ratio and average particle diameter of the second anisotropically shaped powder can be controlled by appropriately selecting the synthesis conditions.

Suitable examples of the production method for the second anisotropically shaped powder include a method of adding an appropriate flux (for example, NaCl, KCl, a mixture of NaCl and KCl, BaCl₂ or KF) to the anisotropically shaped powder-producing raw material and heating these at a predetermined temperature (flux method), and a method of heating an amorphous powder having the same composition as the second anisotropically shaped powder to be produced, together with an aqueous alkali solution in an autoclave (hydrothermal synthesis method).

On the other hand, the compound represented by formula (2) has a very small lattice crystal anisotropy and therefore, it is difficult to directly synthesize the first anisotropically shaped powder comprising the compound represented by formula (2) and using a specific crystal plane as the orienting plane (that is, the anisotropically shaped powder A). However, the anisotropically shaped powder A can be produced by using the second anisotropically shaped powder as a reactive template and heating this powder and the second reaction raw material satisfying predetermined conditions in a flux.

In the case of synthesizing the anisotropically shaped powder A by using the second anisotropically shaped powder as a reaction template, when the reaction conditions are optimized, only a change in the crystal structure takes place and a change in the powder shape scarcely occurs. Also, the average particle diameter and/or aspect ratio of the second anisotropically shaped powder are usually maintained as-is before and after the reaction, but when the reaction conditions are optimized, the average grain size and/or aspect ratio of the obtained anisotropically shaped powder A can be increased or decreased.

However, and in order to easily synthesize the anisotropically shaped powder A capable of being readily oriented in one direction at the forming, the second anisotropically shaped powder used for the synthesis also preferably has a shape allowing for easy orientation in one direction at the forming.

That is, also in the case of synthesizing the anisotropically shaped powder by using the second anisotropically shaped powder as a reactive template, the average aspect ratio of the second anisotropically shaped powder is preferably at least 3 or more, more preferably 5 or more, still more preferably 10 or more. On the other hand, in order to prevent cracking in later steps, the average aspect ratio is preferably 100 or less. The average particle diameter of the second anisotropically shaped powder is preferably from 0.05 to 20 μm, more preferably from 0.1 to 10 μm.

The “second reaction raw material” means a material of reacting the second anisotropically shaped powder to produce the anisotropically shaped powder A comprising at least the compound represented by formula (2). In this case, the second reaction raw material may be a material of producing only the compound represented by formula (2) by the reaction with the second anisotropically shaped power or may be a material of producing both the compound represented by formula (2) and a surplus component. The “surplus component” as used herein means a material except for the objective compound represented by formula (2). In the case where a surplus component is produced from the second anisotropically shaped powder and the second reaction raw material, the surplus component preferably comprises a material that is easy to thermally or chemically remove.

As for the form of the second reaction raw material, for example, an oxide powder, a composite oxide powder, a salt such as carbonate, nitrate and oxalate, and an alkoxide can be used. Also, the composition of the second reaction raw material can be determined according to the composition of the compound represented by formula (2) to be produced and the composition of the second anisotropically shaped powder.

For example, in the case where an anisotropically shaped powder A comprising NN which is a kind of the compound represented by formula (2) is synthesized by using a second anisotropically shaped powder comprising Bi_{2.5}Na_{0.5}Nb₂O₉ (hereinafter, referred to as “BINN2”) which is a kind of the bismuth layered perovskite-type compound represented by formula (4), an Na-containing compound (e.g., oxide, hydroxide, carbonate, nitrate) can be used as the second reaction raw material. In this case, an Na-containing compound corresponding to 1.5 mol of Na atom based on 1 mol of BINN2 may be added as the second reaction raw material.

When from 1 to 500 wt % of an appropriate flux (for example, NaCl, KCl, a mixture of NaCl and KCl, BaCl₂ or KF) is added to the second anisotropically shaped powder and second reaction material each having the composition described above and heated to an eutectic point•melting point, NN and a surplus component mainly comprising Bi₂O₃ are produced. Bi₂O₃ has a low melting point and is weak to acid and therefore, when the obtained reaction product after removing the flux therefrom by hot water washing or the like is heated to a high temperature or washed with acid, an anisotropically shaped powder A comprising NN with the {100} plane being the orienting plane can be obtained.

Furthermore, for example, in the case where an anisotropically shaped powder A comprising K_{0.5}Na_{0.5}NbO₃ (hereinafter, referred to as “KNN”) which is a kind of the compound represented by formula (2) is synthesized by using the second anisotropically shaped powder comprising BINN2, an Na-containing compound (e.g., oxide, hydroxide, carbonate, nitrate) and a K-containing compound (e.g., oxide, hydroxide, carbonate, nitrate), or a compound containing both Na and K, may be used as the second reaction raw material. In this case, an Na-containing compound corresponding to 0.5 mol of Na atom and a K-containing compound corresponding to 1 mol of K atom based on 1 mol of BINN2 may be added as the second reaction raw material.

When from 1 to 500 wt % of an appropriate flux is added to the second anisotropically shaped powder and the second reaction raw material each having the composition described above and heated to an eutectic point•melting point, KNN and a surplus component mainly comprising Bi₂O₃ are produced and therefore, an anisotropically shaped powder A comprising KNN with the {100} plane being the orienting plane can be obtained by removing the flux and Bi₂O₃ from the obtained reaction product.

The same applies to the case of producing only the compound represented by formula (2) through a reaction of the second anisotropically shaped powder with the second reaction raw material, and the second anisotropically shaped powder having a predetermined composition and the second reaction raw material having a predetermined composition may be heated in an appropriate flux, whereby a compound represented by formula (2) having an objective composition can be produced in the flux. When the flux is removed from the obtained reaction product, an anisotropically shaped powder A comprising the compound represented by formula (2) with a certain plane being the orienting plane can be obtained.

The compound represented by formula (2) has a small crystal lattice anisotropy and therefore, it is difficult to directly produce an anisotropically shaped powder A and also to directly produce an anisotropically shaped powder A with the orienting plane being an arbitrary crystal plane.

On the other hand, the layered perovskite-type compound has a large crystal lattice anisotropy and, therefore, an anisotropically shaped powder can be directly synthesized with ease. Also, in many cases, the orienting plane of an anisotropically shaped powder comprising a layered perovskite-type compound has a lattice matching with a specific crystal plane of the compound represented by formula (2). Furthermore, the compound represented by formula (2) is thermodynamically stable as compared with the layered perovskite-type compound.

Therefore, when the second anisotropically shaped powder which comprises a layered perovskite-type compound and in which the orienting plane has lattice matching with a specific crystal plane of the compound represented by formula (2) is reacted with the second reaction raw material in an appropriate flux, the second anisotropically shaped powder can function as a reactive template and, as a result, an anisotropically shaped powder A comprising the compound represented by formula (2) and taking the orientation direction of the second anisotropically shaped powder can be easily synthesized.

In addition, when the compositions of the second anisotropically shaped powder and second reaction raw material are optimized, the A-site element contained in the second anisotropically shaped powder (hereinafter, this element is referred to as a “surplus A-site element”) is discharged as a surplus component and at the same time, an anisotropically shaped powder A comprising the compound represented by formula (2) and not containing a surplus A-site element is produced.

Particularly, in the case where the second anisotropically shaped powder comprises a bismuth layered perovskite-type compound represented by formula (4), Bi is discharged as a surplus A-site element to produce a surplus component mainly comprising Bi₂O₃. Therefore, when the surplus component is thermally or chemically removed, an anisotropically shaped powder A containing substantially no Bi and comprising the compound represented by formula (2) with a specific crystal plane being the orienting plane can be obtained.

The production method of the grain oriented ceramic is described below.

In the production method of the grain oriented ceramic, the above-described mixing step, forming step and heat-treating step are performed to produce the grain oriented ceramic.

The mixing step is a step of mixing (i) a first anisotropically shaped powder comprising orienting particle having an orienting plane on which a specific crystal plane is oriented, (ii) a first reaction raw material of reacting with the first anisotropically shaped powder to produce an isotropic perovskite-type compound represented by formula (1): {Liₓ(K_{1-y}Na_{y})₁₋ₓ}(Nb_{1-z-w}Ta_{z}Sb_{w})O₃ (wherein 0≦x≦0.2, 0≦y≦1, 0≦z≦0.4, 0≦w≦0.2 and x+z+w>0), and (iii) any one or more additional element selected from metal elements, semimetal elements, transition metal elements, noble metal elements and alkaline earth metal elements belonging to Groups 2 to 15 of the Periodic Table, thereby producing a raw material mixture,

In the first anisotropically shaped powder, the orienting plane of the orienting particle has lattice matching with the specific crystal plane in the compound represented by formula (1). As for the first anisotropically shaped powder, the above-described anisotropically shaped powder A, second anisotropically shaped powder or the like can be used.

The first reaction raw material reacts with the first anisotropically shaped powder to produce at least the compound represented by formula (1). In this case, the first reaction raw material may be a material that produces only the compound represented by formula (1) by the reaction with the first anisotropically shaped power or may be a material that produces both the compound represented by formula (1) and a surplus component. In the case where a surplus component is produced by the reaction of the first anisotropically shaped powder and the first reaction raw material, the surplus component is preferably a material easy to thermally or chemically remove.

The composition of the first reaction raw material can be determined according to the composition of the first anisotropically shaped powder and the compound represented by formula (1) to be produced. Also, as the first reaction raw material, for example, an oxide powder, a composite oxide powder, a hydroxide powder, a salt such as carbonate, nitrate and oxalate, or an alkoxide can be used.

More specifically, for example, in the case where a grain oriented ceramic comprising the compound represented by formula (1) is produced by using, as the first anisotropically shaped powder, an anisotropically shaped powder A having a KNN or NN composition, this may be attained when a mixture of compounds containing at least one element of Li, K, Na, Nb, Ta and Sb is used as the first reaction raw material, and the anisotropically shaped powder A and the first reaction raw material are blended at a stoichiometric ratio of allowing for production of the compound represented by formula (1) having an objective composition.

Furthermore, for example, in the case where a grain oriented ceramic comprising the compound represented by formula (1) is produced by using, as the first anisotropically shaped powder, the second anisotropically shaped powder having a composition represented by formula (4), this may be attained when a mixture of compounds containing at least one element of Li, K, Na, Nb, Ta and Sb is used as the first reaction raw material, and the second anisotropically shaped powder and the first reaction raw material are blended at a stoichiometric ratio of allowing for production of the compound represented by formula (1) having an objective composition. The same applies to the case of producing a grain oriented ceramic having other composition.

The orienting particle preferably has a plate-like shape (claim 17).

In this case, it becomes easy to produce a formed body at the forming step described later such that the orienting plane of the first anisotropically shaped powder is oriented nearly in the same direction in the formed body.

The orienting particles preferably comprise a compound represented by formula (2): {Liₓ(K_{1-y}Na_{y})₁₋ₓ}(Nb_{1-z-w}Ta_{z}Sb_{w})O₃ (wherein 0≦x≦1, 0≦y≦1, 0≦z≦1 and 0≦w≦1) (claim 18).

In this case, a grain oriented ceramic having a high orientation degree can be produced.

That is, as described above, the compound represented by formula (2) has good lattice matching with the compound represented by formula (1) and therefore, the anisotropically shaped powder comprising the orienting particle represented by formula (2) with a certain plane being the orienting plane can function as a good reactive template for the production of the grain oriented ceramic.

The orienting plane of the orienting particle is preferably a pseudo-cubic {100} plane (claim 19).

In this case, the temperature dependency of displacement generated under a large electric field can be improved in the tetragonal crystal region where the orientation axis and the polarization axis are agreeing.

In the mixing step, any one or more additional element selected from metal elements, semimetal elements, transition metal elements, noble metal elements and alkaline earth metal elements belonging to Groups 2 to 15 of the Periodic Table is added to the first anisotropically shaped powder and first reaction raw material blended at a predetermined ratio.

The additional element can be added in an amount of 0.0001 to 0.15 mol per mol of the compound represented by formula (1) to be produced.

If the amount of the additional element added is less than 0.0001 mol or exceeds 0.15 mol, the piezoelectric properties or dielectric properties of the grain oriented ceramic may decrease.

The additional element may be added as the additional element as-is but may also be added in the form of a compound containing the additional element.

Furthermore, the additional element may be added such that the additional element is arranged by replacing at least a part of Li, K, Na, Nb, Ta and Sb in the compound represented by formula (1). In order to arrange the additional element by replacement, for example, the raw materials may be blended at a stoichiometric ratio in expectation of replacement by the additional element.

More specifically, for example, when Li of the compound represented by formula (1) is replaced by the additional element, the amount of the Li-containing compound in the first anisotropically shaped powder or first reaction raw material is decreased, and the additional element or a compound containing the additional element is added and mixed in an amount of compensating for the decrease and at the same time, giving as a whole a stoichiometric ratio of allowing for production of the compound represented by formula (1), whereby the replacement can be realized. Also in the case of replacing other atoms such as K, Na, Nb, Ta and Sb in the compound represented by formula (1), the amount of the compound containing such an atom is decreased in the first anisotropically shaped powder or first reaction raw material, and the additional element intended to replace the atom or a compound containing the additional element is added in an amount of compensating for the decrease, whereby the replacement can be realized.

The additional element can also be externally added. The additional element externally added is located in the crystal grain comprising the compound represented by formula (1) or at the grain boundary in the form of the additional simple element as-is or a compound containing the additional element.

The additional element is preferably any one or more element selected from Mg, Ca, Sr, Ba, Sc, Ti, V, Cr, Mn, Fe, Co, Ni, Cu, Zn, Y, Zr, Mo, Ru, Rh, Pd, Ag, Hf, W, Re, Pt, Au, Ir, Os, B, Al, Ga, In, Si, Ge, Sn and Bi.

In this case, the piezoelectric properties or dielectric properties of the grain oriented ceramic obtained can be enhanced.

In the mixing step, in addition to the first anisotropically shaped powder, first reaction raw material and additional element blended at a predetermined ratio, an amorphous fine powder comprising a compound having the same composition as the compound represented by formula (1) which is obtained by the reaction of those substances (hereinafter, this fine powder is referred to as a “compound fine powder”), and/or a sintering aid such as CuO may also be added. The addition of the compound fine powder or sintering aid is advantageous in that an increase in the density of the sintered body is more facilitated.

In the case of blending the compound fine powder, if the blending ratio of the compound fine powder is excessively large, the blending ratio of the first anisotropically shaped powder occupying in the entire raw material inevitably decreases and the orientation degree of the specific crystal plane may decrease. Therefore, an optimum blending ratio of the compound fine powder is preferably selected in accordance with the required sintered body density and orientation degree.

The blending ratio of the first anisotropically shaped powder is preferably set such that in the compound of formula (1) represented by ABO₃, the ratio at which the A site is occupied by one component element or a plurality of component elements in the first anisotropically shaped powder is from 0.01 to 70 atm %, more preferably from 0.1 to 50 atm %, still more preferably from 1 to 10 atm %.

The mixing of the first anisotropically shaped powder, first reaction raw material and additional element as well as the compound fine powder and sintering aid blended as needed may be performed by a dry process or by a wet process of adding an appropriate dispersion medium such as water or alcohol. At this time, if desired, a binder and/or a plasticizer may also be added.

The forming step is described below.

The forming step is a step of forming the raw material mixture such that the orienting plane of the first anisotropically shaped powder is oriented nearly in the same direction in the formed body.

In this case, the forming may be performed to yield plane orientation of the first anisotropically shaped powder or axis orientation of the first anisotropically shaped powder.

The forming method is sufficient if it is a method capable of orienting the first anisotropically shaped powder. As for the preferred forming method for plane-orienting the first anisotropically shaped powder, specific examples thereof include a doctor blade method, a press forming method and a roll-pressing method. Also, as for the preferred forming method for axis-orienting the first anisotropically shaped powder, specific examples thereof include an extrusion forming method and a centrifugal forming method.

The formed body where the first anisotropically shaped powder is plane-oriented (hereinafter, referred to as a “plane-oriented formed body”) may be further subjected to a treatment such as lamination compression, pressing or roll-pressing (hereinafter, referred to as a “plane orientation treatment”) so as to increase the thickness or elevate the orientation degree of the formed body.

In this case, any one plane-orientation treatment may be applied to the plane-oriented formed body, but two or more plane-orientation treatments may also be applied. Furthermore, one plane-orientation treatment may be repeatedly applied to the plane-oriented formed body, or two or more plane-orientation treatments may be individually repeated multiple times.

The heat-treating step is described below.

The heat-treating step is a step of heating the formed body to react the first anisotropically shaped powder and the first reaction raw material, thereby producing a polycrystalline body which comprises the isotropic perovskite-type compound represented by formula (1) and in which a certain plane of the crystal grain is oriented.

In the heat-treating step, the formed body is heated and, as a result, the isotropic perovskite-type compound represented by formula (1) is produced. At the same time, sintering of the isotropic perovskite-type compound proceeds. At this time, the additional element is added by replacing at least a part of Li, K, Na, Nb, Ta and Sb in the compound represented by formula (1) or arranged in the crystal grain and/or at the grain boundary of the polycrystal comprising the compound represented by formula (1).

Furthermore, in the heat-treating step, a surplus component is simultaneously produced depending on the composition of the first anisotropically shaped powder and/or first reaction raw material.

As for the heating temperature in the heat-treating step, an optimum temperature may be selected, for example, according to the composition of the first anisotropically shaped powder or first reaction raw material used and the composition of the grain oriented ceramic to be produced, so that the reaction and/or sintering can efficiently proceed and a reaction product having an objective composition can be produced.

For example, in the case where a grain oriented ceramic comprising the compound represented by formula (1) is produced by using the anisotropically shaped powder A having a KNN composition, the heat treatment may be performed at a heating temperature of 900 to 1,300° C. Within this temperature range, a further optimum heating temperature may be decided according to the composition of the compound represented by formula (1) which is an objective substance. As for the heating time, an optimum time may be selected according to the heating temperature so that a desired sintered body density can be obtained.

Furthermore, in the case where a surplus component is produced by the reaction of the first anisotropically shaped powder and the first reaction raw material, the surplus component may be caused to remain as a sub-phase in the sintered body, or the surplus component may be removed from the sintered body. In the case of removing the surplus component, examples of the method therefor include a thermal removing method and a chemical removing method.

The thermal removing method includes, for example, a method of evaporating the surplus component by heating a sintered body in which the compound represented by formula (1) and a surplus component are produced (hereinafter, referred to as an “intermediate sintered body”), at a predetermined temperature. More specifically, a method of heating the intermediate sintered body under reduced pressure or in oxygen for a long time at a temperature of causing evaporation of the surplus component is preferred.

As for the heating temperature at the time of thermally removing the surplus component, an optimum temperature may be selected according to the composition of the compound represented by formula (1) and/or surplus component, so that evaporation of the surplus component can efficiently proceed and production of a by-product can be suppressed. For example, in the case where the surplus component is a bismuth oxide single phase, the heating temperature is preferably from 800 to 1,300° C., more preferably from 1,000 to 1,200° C.

On the other hand, examples of the method of chemically removing the surplus component include a method of dipping the intermediate sintered body in a treating solution having a property of eroding only the surplus component, and leaching out the surplus component. As for the treating solution used here, an optimal treating solution may be selected according to the composition of the compound represented by formula (1) and/or surplus component. For example, in the case where the surplus component is a bismuth oxide single phase, an acid such as nitric acid or hydrochloric acid can be used as the treating solution. Particularly, nitric acid is suitable as the treating solution for chemically extracting the surplus component mainly comprising bismuth oxide.

The reaction of the first anisotropically shaped powder with the first reaction raw material and the removal of the surplus component may be performed at any timing, that is, simultaneously, sequentially or individually. For example, the removal of a surplus component may be performed simultaneously with the reaction by placing the formed body under reduced pressure or in a vacuum and directly heating it to a temperature at which both the reaction of the first anisotropically shaped powder with the first reaction raw material and the evaporation of the surplus component proceed efficiently. Incidentally, at the reaction of the first anisotropically shaped powder with the first reaction raw material, the additional element is substituted to the compound represented by formula (1) which is an objective substance, or may be located in the crystal grain or/and at the grain boundary as described above.

The surplus component may also be removed, for example, by a method where an intermediate sintered body is produced by heating the formed body in air or in oxygen at a temperature allowing for efficient proceeding of the reaction of the first anisotropically shaped powder with the first reaction raw material, and the intermediate sintered body is successively heated under reduced pressure or in vacuum at a temperature allowing for efficient proceeding of the evaporation of the surplus component, or a method where, after the production of an intermediate sintered body, the intermediate sintered body is successively heated in air or in oxygen for a long time at a temperature allowing for efficient proceeding of the evaporation of the surplus component.

Furthermore, the surplus component may be chemically removed, for example, by producing the intermediate sintered body, cooling the sintered body to room temperature, and dipping the intermediate sintered body in a treating solution, or the surplus component may be thermally removed by producing the intermediate sintered body, cooling it to room temperature, and again heating the intermediate sintered body in a predetermined atmosphere at a predetermined temperature.

In the case where the formed body obtained in the forming step contains a binder, a heat treatment mainly for the degreasing purpose may be performed before the heat-treating step. In this case, the degreasing temperature may be set to a temperature high enough to thermally decompose the binder. However, when the raw material contains a readily volatile substance (for example, Na compound), the degreasing is preferably performed at 500° C. or less.

Also, when the formed body is degreased, the orientation degree of the first anisotropically shaped powder in the formed body may decrease, or cubical expansion of the formed body may occur. In such a case, a cold isostatic pressing (CIP) treatment is preferably applied to the degreased formed body before performing the heat-treating step. This treatment can prevent a decrease in the orientation degree resulting from degreasing or a decrease in the sintered body density ascribable to cubical expansion of the formed body.

Furthermore, in the case where a surplus component is produced by the reaction of the first anisotropically shaped powder with the first reaction raw material and the surplus component is removed, the intermediate sintered body from which the surplus component is removed may be subjected to a cold isostatic pressing treatment and then again fired. Also, to elevate the sintered body density and the orientation degree, the sintered body after the heat-treating process may be further subjected to hot pressing. In addition, the method of adding the compound fine compound, the CIP treatment, the hot pressing and the like may be used in combination.

In the production method of the sixth invention, it is also possible to synthesize the anisotropically shaped powder A comprising the compound represented by formula (2) by using, as a reactive template, the second anisotropically shaped powder comprising a layered perovskite-type compound allowing for easy synthesis of the anisotropically shaped powder and then produce the grain oriented ceramic by using the anisotropically shaped powder A as a reactive template. According to this method, even in the case of a compound represented by formula (1) having a small crystal lattice anisotropy, the grain oriented ceramic in which an arbitrary crystal plane is oriented can be easily produced at a low cost.

Moreover, when the compositions of the second anisotropically shaped powder and second reaction raw material are optimized, even an anisotropically shaped powder A not containing a surplus A-site element can be synthesized. Therefore, the composition of the A-site element can be easily controlled and a grain oriented ceramic comprising, as the main phase, the compound represented by formula (1) having a composition not obtainable by conventional methods can be produced.

Also, the above-described second anisotropically shaped powder comprising a layered perovskite-type compound can be used as the first anisotropically shaped powder. In this case, the compound represented by formula (1) can be synthesized simultaneously with sintering in the heat-treating step. Furthermore, when the composition of the second anisotropically shaped powder oriented in the formed body and the composition of the first reaction raw material to be reacted therewith are optimized, not only the objective compound represented by formula (1) can be synthesized but also the surplus A-site element can be discharged as a surplus component from the second anisotropically shaped powder.

In addition, when the second anisotropically shaped powder of producing a surplus component easy to thermally or chemically remove is used as the first anisotropically shaped powder, a grain oriented ceramic containing substantially no surplus A-site element and comprising the compound represented by formula (1), with a specific crystal plane being oriented, can be obtained.

### EXAMPLES

### Example 1

Examples of the grain oriented ceramic of the present invention are described below.

The grain oriented ceramic of this Example comprises, as the main phase, a polycrystalline body containing 0.01 mol of Pd as an additional element per mol of an isotopic perovskite-type compound represented by {Li_{0.03}(K_{0.5}Na_{0.5})_{0.97}}(Nb_{0.80}Ta_{0.20})O₃. In the grain oriented ceramic of the present invention, a specific crystal plane of each crystal grain constituting the polycrystalline body is oriented.

In the production method of the grain oriented ceramic of this Example, a mixing step, a forming step and a heat-treating step are performed.

In the mixing step, a first anisotropically shaped powder comprising orienting particle having an oriented plate where a specific crystal plane is oriented, a first reaction raw material, which reacts with the first anisotropically shaped powder to produce {Li_{0.03}(K_{0.5}Na_{0.5})_{0.97}}(Nb_{0.80}Ta_{0.20})O₃, and a compound containing Pd working out to an additional element are mixed to produce a raw material mixture.

In the forming step, the raw material mixture is formed such that the orienting plane of the first anisotropically shaped powder is oriented nearly in the same direction in the formed body.

In the heat-treating step, the formed body is heated to react the first anisotropically shaped powder with the first reaction raw material to produce a polycrystalline sintered body which comprises {Li_{0.03}(K_{0.5}Na_{0.5})_{0.97}}(Nb_{0.80}Ta_{0.20})O₃ and in which a certain plane of the crystal grains is oriented.

Furthermore, in the mixing step, the additional element is added in an amount of 0.01 mol per mol of {Li_{0.03} (K_{0.5}Na_{0.5})_{0.97}}(Nb_{0.80}Ta_{0.20})O₃.

In the orienting particle, the orienting plane is a developed plane which is a plane occupying a largest area in the orienting particle. The orienting plane of the orienting particle has lattice matching with the certain plane oriented in the crystal grain constituting the polycrystalline sintered body obtained after the heat-treating step.

The production method of the grain oriented ceramic of this Example is described in detail below.

(1) Synthesis of Plate-Like NN Powder

A Bi₂O₃ powder, an Na₂CO₃ powder and an Nb₂O₅ powder each having a purity of 99.99% or more were weighted to give a Bi_{2.5}Na_{3.5}Nb₅O₁₈ (hereinafter, referred to as “BINN5”) composition at a stoichiometric ratio and then wet-mixed and, to this raw material, 50 wt % of NaCl as a flux was added, followed by dry-mixing for 1 hour.

The obtained mixture was charged into a platinum crucible, heated at a temperature of 850° C. for 1 hour and after completely melting the flux, further heated at 1,100° C. for 2 hours, thereby synthesizing BINN5. Here, both the heating rate and cooling rate were 200° C./h. After cooling, the flux was removed from the reaction product by hot water washing to obtain a BINN5 powder. The obtained BINN5 powder was a plate-like powder with the developed plane being a {001} plane.

Subsequently, an Na₂CO₃ powder in an amount necessary for the synthesis of NN(NaNbO₃) was added to the plate-like powder comprising BINN5, and these powders were mixed and then heat-treated at a temperature of 950° C. for 8 hours in a platinum crucible by using NaCl as a flux.

In the obtained reaction product, Bi₂O₃ was contained in addition to the NN powder. Therefore, the reaction product after removing the flux therefrom was dipped in HNO₃ (1N) to dissolve Bi₂O₃ produced as a surplus component, and the NN powder was separated by filtering the resulting solution and then washed with ion-exchanged water at 80° C. The obtained NN powder was a plate-like powder (plate-like NN powder) having an average grain diameter of 10 to 20 μm and an aspect ratio of approximately from 10 to 20, with the developed plane being a pseudo-cubic {100} plane. In the following, this plate-like NN powder was used as the first anisotropically shaped powder (template).

(2) Synthesis of Grain Oriented Ceramic Having {Li_{0.03}(K_{0.5}Na_{0.5})_{0.97}}(Nb_{0.80}Ta_{0.20})O₃ Composition

The plate-like NN powder produced above, a non-plate-like NN powder, a KN powder, a KT (KTaO₃) powder and an LT (LiTaO₃) powder, as first reaction powders, were blended at a stoichiometric ratio of giving the objective composition, that is, {Li_{0.03}(K_{0.5}Na_{0.5})_{0.97}}(Nb_{0.80}Ta_{0.20})O₃, and after a compound containing Pd (PdO powder having a purity of 99.99% or more) working out to an additional element was further blended at a ratio of 0.01 mol per mol of {Li_{0.03}(K_{0.5}Na_{0.5})_{0.97}}(Nb_{0.80}Ta_{0.20})O₃, the powders were wet-mixed for 20 hours.

To the resultant slurry, a binder (Eslec (registered trademark) BH-3, produced by Sekisui Chemical Co., Ltd.) and a plasticizer (butyl phthalate) were added each in an amount of 10.35 g per mol of {Li_{0.03}(K_{0.5}Na_{0.5})_{0.97}}(Nb_{0.80}Ta_{0.20})O₃ synthesized from the starting materials, followed by mixing for 2 hours.

Here, the plate-like NN powder (template) was blended in an amount such that Na in an amount corresponding to 5 atm % of the elements occupying the A site of {Li_{0.03}(K_{0.5}Na_{0.5})_{0.97}}(Nb_{0.80}Ta_{0.20})O₃ synthesized from starting materials was supplied from the plate-like NN powder.

Also, the non-plate-like NN powder, the KN powder, the KT powder and the LT powder were produced by a solid-phase reaction process where a mixture containing a K₂CO₃ powder, an Na₂CO₃ powder, an Nb₂O₅ powder, a Ta₂O₅ powder and an Li₂CO₃ powder each in a predetermined amount and each having a purity of 99.99% or more was heated at a temperature of 750° C. for 5 hours and the reaction product was ground in a ball mill.

The slurry, after mixing as above, was formed into a tape with a thickness of 100 μm by using a doctor blade device (tape casting method), and these tapes were stacked, press-bonded and roll-pressed to obtain a 1.5 mm-thick plate-like formed body. The obtained plate-like formed body was then heated in air to degrease a green body. The degreasing was performed in air under the temperature control that the temperature was elevated to 600° C. at a heating rate of 50° C./h and after holding and thereby heating the formed body at this temperature of 600° C. for 2 hours, lowered at a furnace cooling rate.

Subsequently, the degreased body was subjected to a CIP treatment at a pressure of 300 MPa and then sintered by heating the formed body in oxygen. The sintering was performed by atmospheric pressure sintering or hot-press sintering (applied load: 35 kg/cm²) under the temperature control that the temperature was elevated to a temperature of 1,000 to 1,200° C. at a heating rate of 200° C./h and after heating (firing) the formed body for 1 to 5 hours, lowered at a cooling rate of 200° C./hr. At this time, as for the firing temperature and firing time, the firing conditions were selected such that the density of the sintered body became maximum between 1,000 and 1,200° C. for 1 to 5 hours, and a dense sintered body having a relative density of 95% or more was produced.

In this way, a grain oriented ceramic was produced. This grain oriented ceramic was designated as Sample E1.

In Sample E1, the Pd as an additional element was externally added in the form of a Pd-containing compound PdO. Accordingly, the additional element Pd in Sample E1 was present in the grain or at the grain boundary of the polycrystalline sintered body comprising {Li_{0.03}(K_{0.5}Na_{0.5})_{0.97}}(Nb_{0.80}Ta_{0.20})O₃.

### Example 2

This Example is a case of producing a grain oriented ceramic containing Ni as an additional element.

In this Example, similarly to Example 1, the plate-like NN powder, non-plate-like NN powder, KN powder, KT powder and LT powder were blended at a stoichiometric ratio of giving the objective composition, that is, {Li_{0.03}(K_{0.5}Na_{0.5})_{0.97}}(Nb_{0.80}Ta_{0.20})O₃, and after an NiO powder having a purity of 99.99% or more, which is a compound containing Ni working out to an additional element, was further blended at a ratio of 0.01 mol per mol of {Li_{0.03}(K_{0.5}Na_{0.5})_{0.97}}(Nb_{0.80}Ta_{0.20})O₃, the powders were wet-mixed for 20 hours.

The resultant slurry was, similarly to Example 1, passed through addition of a binder and a plasticizer, mixing, forming, degreasing and heating (firing) to produce a dense grain oriented ceramic having a relative density of 95% or more. This is designated as Sample E2.

That is, Sample E2 was produced in the same manner as Sample E1 of Example 1 except that Ni was blended as an additional element.

In Sample E2, the Ni as an additional element was externally added in the form of an Ni-containing compound NiO. Accordingly, the additional element Ni in Sample E2 was present in the grain or at the grain boundary of the polycrystalline sintered body comprising {Li_{0.03}(K_{0.5}Na_{0.5})_{0.97}}(Nb_{0.80}Ta_{0.20})O₃.

### Example 3

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ and containing In.

In this Example, similarly to Example 1, the plate-like NN powder, non-plate-like NN powder, KN powder and KT powder were prepared. Also, an LS (LiSbO₃) powder was prepared. The Ls powder was produced, similarly to the NN powder, KN powder and KT powder, by a solid-phase reaction process where a mixture containing a Li₂CO₃ powder and an Sb₂CO₅ powder each in a predetermined amount was heated at a temperature of 750° C. for 5 hours and the reaction product was ground in a ball mill.

These plate-like NN powder, non-plate-like NN powder, KN powder, KT powder, LS powder and NS powder were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an In₂O₃ powder having a purity of 99.99% or more, which is a compound containing In working out to an additional element, was further blended at a ratio of 0.005 mol per mol of {Li_{0.04}(K_{0.5}Na_{0.5})_{0.96}}(Nb_{0.86}Ta_{0.10}Sb_{0.04})O₃, the powders were wet-mixed for 20 hours. Incidentally, by blending in this way 0.005 mol of In₂O₃ per mol of {Li_{0.04}(K_{0.5}Na_{0.5})_{0.96}}(Nb_{0.86}Ta_{0.10}Sb_{0.04})O₃, 0.01 mol of In was blended.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E3.

In Sample E3, the In as an additional element was externally added in the form of an In-containing compound In₂O₃. Accordingly, the additional element In in Sample E3 was present in the grain or at the grain boundary of the polycrystalline sintered body comprising {Li_{0.04}(K_{0.5}Na_{0.5})_{0.96}}(Nb_{0.86}Ta_{0.10}Sb_{0.04})O₃.

### Example 4

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ having added thereto Ca to replace a part of K and Na.

In this Example, similarly to Example 3, the plate-like NN powder, non-plate-like NN powder, KN powder, KT powder and LS powder were prepared. Also, a CaCO₃ powder having a purity of 99.99% or more, which is a compound containing Ca working out to an additional element, was prepared.

These raw materials were blended at a stoichiometric ratio of giving a composition of {Li_{0.04}(K_{0.5}Na_{0.5})_{0.94}Ca_{0.01}}(Nb_{0.86}Ta_{0.10}Sb_{0.04})O₃ resulting from addition of Ca to replace a part of K and Na of {Li_{0.04}(K_{0.5}Na_{0.5})_{0.96}}(Nb_{0.86}Ta_{0.10}Sb_{0.04})O₃, and then wet-mixed for 20 hours.

The resultant slurry was, similarly to Example 1, passed through addition of a binder and a plasticizer, mixing, forming, degreasing and heating (firing) to produce a dense grain oriented ceramic having a relative density of 95% or more. This is designated as Sample E4.

In Sample E4, the additional element Ca was added so as to replace a part of K and Na which are A-site elements in {Li_{0.04}(K_{0.5}Na_{0.5})_{0.96}}(Nb_{0.86}Ta_{0.10}Sb_{0.04})O₃. The additional element Ca was added to occupy 1 atm % in the entire A-site amount of {Li_{0.04}(K_{0.5}Na_{0.5})_{0.96}}(Nb_{0.86}Ta_{0.10}Sb_{0.04})O₃.

### Example 5

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ and containing Si.

In this Example, similarly to Example 3, the plate-like NN powder, non-plate-like NN powder, KN powder, KT powder and LS powder were prepared.

These raw materials were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an SiO₂ powder having a purity of 99.99% or more, which is a compound containing Si working out to an additional element, was further blended at a ratio of 0.01 mol per mol of {Li_{0.04}(K_{0.5}Na_{0.5})_{0.96}}(Nb_{0.86}Ta_{0.10}Sb_{0.04})O₃, the powders were wet-mixed for 20 hours.

The resultant slurry was, similarly to Example 1, passed through addition of a binder and a plasticizer, mixing, forming, degreasing and heating (firing) to produce a dense grain oriented ceramic having a relative density of 95% or more. This is designated as Sample E5.

In Sample E5, the Si as an additional element was externally added in the form of an Si-containing compound SiO₂. Accordingly, the additional element Si in Sample E5 was present in the grain or at the grain boundary of the polycrystalline sintered body comprising {Li_{0.04}(K_{0.5}Na_{0.5})_{0.96}}(Nb_{0.86}Ta_{0.10}Sb_{0.04})O₃.

### Example 6

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ and containing Ag.

In this Example, similarly to Example 3, the plate-like NN powder, non-plate-like NN powder, KN powder, KT powder and LS powder were prepared.

These raw materials were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an Ag₂O powder having a purity of 99.99% or more, which is a compound containing Ag working out to an additional element, was further blended at a ratio of 0.005 mol per mol of {Li_{0.04}(K_{0.5}Na_{0.5})_{0.96}}(Nb_{0.86}Ta_{0.10}Sb_{0.04})O₃, the powders were wet-mixed for 20 hours. Incidentally, by blending in this way 0.005 mol of Ag₂O per mol of {Li_{0.04}(K_{0.5}Na_{0.5})_{0.96}}(Nb_{0.86}Ta_{0.10}Sb_{0.04})O₃, 0.01 mol of Ag was blended.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E6.

In Sample E6, the Ag as an additional element was externally added in the form of an Ag-containing compound Ag₂O. Accordingly, the additional element Ag in Sample E6 was present in the grain or at the grain boundary of the polycrystalline sintered body comprising {Li_{0.04}(K_{0.5}Na_{0.5})_{0.96}}(Nb_{0.86}Ta_{0.10}Sb_{0.04})O₃.

### Example 7

This Example is a case of producing a grain oriented ceramic comprising, as the main phase, a polycrystalline sintered body having the same composition as in Example 6 by reacting the plate-like powder with (Li_{0.0421}K_{0.5053}Na_{0.4526})(Nb_{0.8526}Ta_{0.1053}Sb_{0.421})O₃.

A plate-lie NN powder was prepared in the same manner as in Example 1.

Subsequently, a (Li_{0.0421}K_{0.5053}Na_{0.4526})(Nb_{0.8526}Ta_{0.1053}Sb_{0.421})O₃ powder was produced by a solid phase process where a mixture containing a K₂CO₃ powder, an Na₂CO₃ powder, an Nb₂O₅ powder, a Ta₂O₅ powder, an Li₂CO₃ powder and an Sb₂O₅ powder each in a predetermined amount and each having a purity of 99.99% or more was heated at a temperature of 750° C. for 5 hours and the reaction product was ground in a ball mill.

Thereafter, the plate-like NN powder and the (Li_{0.0421}K_{0.5053}Na_{0.4526})(Nb_{0.8526}Ta_{0.1053}Sb_{0.421})O₃ powder were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after Ag₂O which is a compound containing Ag working out to an additional element was further blended at a ratio of 0.005 mol per mol of {Li_{0.04}(K_{0.5}Na_{0.5})_{0.96}}(Nb_{0.86}Ta_{0.10}Sb_{0.04})O₃, the powders were wet-mixed for 20 hours.

Here, the plate-like NN powder (template) was blended, similarly to Example 1, in an amount such that Na in an amount corresponding to 5 atm % of the elements occupying the A site of {Li_{0.04}(K_{0.5}Na_{0.5})_{0.96}}(Nb_{0.86}Ta_{0.10}Sb_{0.04})O₃ synthesized from starting materials was supplied from the plate-like NN powder.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E7.

In Sample E7, the Ag as an additional element was externally added in the form of an Ag₂O powder having a purity of 99.99%, which is an Ag-containing compound. Accordingly, the additional element Ag in Sample E7 was present in the grain or at the grain boundary of the polycrystalline sintered body comprising {Li_{0.04}(K_{0.5}Na_{0.5})_{0.96}}(Nb_{0.86}Ta_{0.10}Sb_{0.04})O₃.

### Example 8

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ having added thereto Si by replacing a part of K and Na.

In this Example, similarly to Example 3, the plate-like NN powder, non-plate-like NN powder, KN powder, KT powder and LS powder were prepared. Also, an SrCO₃ powder having a purity of 99.99% or more, which is a compound containing Sr working out to an additional element, was prepared.

These raw materials were blended at a stoichiometric ratio of giving a composition of {Li_{0.04}(K_{0.5}Na_{0.5})_{0.94}Sr_{0.01}}(Nb_{0.86}Ta_{0.10}Sb_{0.04})O₃ resulting from addition of Sr to replace a part of K and Na of {Li_{0.04}(K_{0.5}Na_{0.5})_{0.96}}(Nb_{0.86}Ta_{0.10}Sb_{0.04})O₃, and then wet-mixed for 20 hours.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E8.

In Sample E8, the additional element Sr was added so as to replace a part of K and Na which are A-site elements in {Li_{0.04}(K_{0.5}Na_{0.5})_{0.96}}(Nb_{0.86}Ta_{0.10}Sb_{0.04})O₃. The additional element Sr was added to occupy 1 atm % in the entire A-site amount of {Li_{0.04}(K_{0.5}Na_{0.5})_{0.96}}(Nb_{0.86}Ta_{0.10}Sb_{0.04})O₃.

### Example 9

This Example is a case of producing a grain oriented ceramic in which the main phase is a polycrystalline sintered body comprising {Li_{0.04}(K_{0.5}Na_{0.5})_{0.96}}(Nb_{0.86}Ta_{0.10}Sb_{0.04})O₃ and containing Pd.

In this Example, similarly to Example 3, the plate-like NN powder, non-plate-like NN powder, KN powder, KT powder and LS powder were prepared.

These raw materials were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after a PdO powder having a purity of 99.99% or more, which is a compound containing Pd working out to an additional element, was further blended at a ratio of 0.01 mol per mol of {Li_{0.04}(K_{0.5}Na_{0.5})_{0.96}}(Nb_{0.86}Ta_{0.10}Sb_{0.04})O₃, the powders were wet-mixed for 20 hours.

The resultant slurry was, similarly to Example 1, passed through addition of a binder and a plasticizer, mixing, forming, degreasing and heating (firing) to produce a dense grain oriented ceramic having a relative density of 95% or more. This is designated as Sample E9.

In Sample E9, the Pd as an additional element was externally added in the form of a Pd-containing compound PdO. Accordingly, the additional element Pd in Sample E9 was present in the grain or at the grain boundary of the polycrystalline sintered body comprising {Li_{0.04}(K_{0.5}Na_{0.5})_{0.96}}(Nb_{0.86}Ta_{0.10}Sb_{0.04})O₃.

### Example 10

This Example is a case of producing a grain oriented ceramic in which the main phase is a polycrystalline sintered body comprising {Li_{0.04}(K_{0.46}Na_{0.54})_{0.96}}(Nb_{0.86}Ta_{0.10}Sb_{0.04})O₃ and containing Pd.

In this Example, similarly to Example 3, the plate-like NN powder, non-plate-like NN powder, KN powder, KT powder and LS powder were prepared.

These raw materials were blended at a stoichiometric ratio of giving the objective composition, that is, {Li_{0.04} (K_{0.46}Na_{0.54})_{0.96}}(Nb_{0.86}Ta_{0.10}Sb_{0.04})O₃, and after a PdO powder having a purity of 99.99% or more, which is a compound containing Pd working out to an additional element, was further blended at a ratio of 0.01 mol per mol of {Li_{0.04}(K_{0.46}Na_{0.54})_{0.96}}(Nb_{0.86}Ta_{0.10}Sb_{0.04})O₃, the powders were wet-mixed for 20 hours.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E10.

In Sample E10, the Pd as an additional element was externally added in the form of a Pd-containing compound PdO. Accordingly, the additional element Pd in Sample E10 was present in the grain or at the grain boundary of the polycrystalline sintered body comprising {Li_{0.04}(K_{0.46}Na_{0.54})_{0.96}}(Nb_{0.86}Ta_{0.10}Sb_{0.04})O₃.

### Example 11

This Example is a case of producing a grain oriented ceramic in which the main phase is a polycrystalline sintered body comprising {Li_{0.75}(K_{0.45}Na_{0.55})_{0.925}}(Nb_{0.83}Ta_{0.095}Sb_{0.075})O₃ having externally added thereto Mn.

A plate-lie NN powder was prepared in the same manner as in Example 1.

Subsequently, an Na₂CO₃ powder, a K₂CO₃ powder, an Li₂CO₃ powder, an Nb₂O₅ powder, a Ta₂O₅ powder and an Sb₂O₅ powder each in a predetermined amount and each having a purity of 99.99% or more were blended at a stoichiometric ratio of giving (Li_{0.079}K_{0.438}Na_{0.483})(Nb_{0.821}Ta_{0.100}Sb_{0.079})O₃, and an MnO₂ powder having a purity of 99.99% or more, which is a compound containing Mn working out to an additional element was further blended at a ratio of 0.001 mol per mol of {Li_{0.75}(K_{0.45}Na_{0.55})_{0.925})(Nb_{0.83}Ta_{0.095}Sb_{0.075})O₃. Thereafter, an (Li_{0.079}K_{0.438}Na_{0.483})(Nb_{0.821}Ta_{0.100}Sb_{0.079})O₃ powder having added thereto a predetermined amount of Mn was produced by a solid phase process where the mixture prepared above was heated at a temperature of 750° C. for 5 hours and the reaction product was ground in a ball mill.

Subsequently, the plate-like NN powder and the (Li_{0.079}K_{0.438}Na_{0.483})(Nb_{0.821}Ta_{0.100}Sb_{0.079})O₃ powder having added thereto a predetermined amount of Mn were blended at a ratio of giving the objective composition, that is, causing Mn to occupy 0.001 mol per mol of {Li_{0.75}(K_{0.45}Na_{0.55})_{0.925}}(Nb_{0.83}Ta_{0.095}Sb_{0.075})O₃, and then these powders were wet-mixed for 20 hours.

Here, the plate-like NN powder (template) was blended, similarly to Example 1, in an amount such that Na in an amount corresponding to 5 atm % of the elements occupying the A site of {Li_{0.75}(K_{0.45}Na_{0.55})_{0.925}}(Nb_{0.83}Ta_{0.095}Sb_{0.075})O₃ synthesized from starting materials was supplied from the plate-like NN powder.

The resultant slurry, similarly to Example 1, passed through addition of a binder and a plasticizer, mixing, forming, degreasing and heating (firing) to produce a dense grain oriented ceramic having a relative density of 95% or more. This is designated as Sample E11.

In Sample E11, the Mn as an additional element was externally added in the form of MnO₂ which is an Mn-containing compound. Accordingly, the additional element Mn in Sample E11 was present in the grain or at the grain boundary of the polycrystalline sintered body comprising {Li_{0.75}(K_{0.45}Na_{0.55})_{0.925}}(Nb_{0.83}Ta_{0.095}Sb_{0.075})O₃.

In this Example, the Mn-containing compound used for supplying Mn as an additional element was MnO₂, but compounds other than MnO₂, such as Mn metal, MnO, Mn₂O₃, Mn₂O₄, Mn₃O₄ and MnCO₃, can also be used.

In order to verify excellent properties of the grain oriented ceramics produced in Examples 1 to 11, comparative ceramics (Samples C1 to C13) were produced in Comparative Examples 1 to 13 below.

### Comparative Example 1

In the ceramic of this Example, the main phase is {Li_{0.03}(K_{0.5}Na_{0.5})_{0.97}}(Nb_{0.80}Ta_{0.20})O₃ similarly to Samples E1 and E2 produced in Examples 1 and 2. The ceramic of this Example is produced by neither using the plate-like NN powder (template) nor adding an additional element.

In this Example, the non-plate-like NN powder, KN powder, KT powder and LT powder were blended at a stoichiometric ratio of giving the objective composition, that is, {Li_{0.03}(K_{0.5}Na_{0.5})_{0.97}}(Nb_{0.80}Ta_{0.20})O₃, and then wet-mixed for 20 hours.

The resultant slurry was, similarly to Example 1, passed through addition of a binder and a plasticizer, mixing, forming, degreasing and heating (firing) to produce a ceramic. This is designated as Sample C1.

That is, Sample C1 was produced in the same manner as Sample E1 of Example 1 except that the plate-like NN powder (template) was not used in the synthesis and the additional element was not added.

### Comparative Example 2

In the ceramic of this Example, the main phase is a polycrystalline sintered body comprising {Li_{0.03}(K_{0.5}Na_{0.5})_{0.97}}(Nb_{0.80}Ta_{0.20})O₃ similarly to Samples E1 and E2 and containing Pd as an additional element. The ceramic of this Example is produced by not using the plate-like NN powder (template).

In this Example, the non-plate-like NN powder, KN powder, KT powder and LT powder were blended at a stoichiometric ratio of giving the objective composition, that is, {Li_{0.03}(K_{0.5}Na_{0.5})_{0.97}}(Nb_{0.80}Ta_{0.20})O₃, and after a PdO powder having a purity of 99.99% or more, which is a compound containing Pd working out to an additional element, was further blended at a ratio of 0.01 mol per mol of {Li_{0.03}(K_{0.5}Na_{0.5})_{0.97}}(Nb_{0.80}Ta_{0.20})O₃, the powders were wet-mixed for 20 hours.

The resultant slurry was, similarly to Example 1, passed through addition of a binder and a plasticizer, mixing, forming, degreasing and heating (firing) to produce a ceramic. This is designated as Sample C2.

That is, Sample C2 was produced in the same manner as Sample E1 of Example 1 except that the plate-like NN powder (template) was not used.

### Comparative Example 3

In the ceramic of this Example, the main phase is a polycrystalline sintered body, similarly to Sample E2 of Example 2, comprising {Li_{0.03}(K_{0.5}Na_{0.5})_{0.97}}(Nb_{0.80}Ta_{0.20})O₃ and containing Ni as an additional element. The ceramic of this Example is produced by not using the plate-like NN powder (template).

In this Example, the non-plate-like NN powder, KN powder, KT powder and LT powder were blended at a stoichiometric ratio of giving the objective composition, that is, {Li_{0.03}(K_{0.5}Na_{0.5})_{0.97}}(Nb_{0.80}Ta_{0.20})O₃, and after an NiO powder having a purity of 99.99% or more, which is a compound containing Ni working out to an additional element, was further blended at a ratio of 0.01 mol per mol of {Li_{0.03}(K_{0.5}Na_{0.5})_{0.97}}(Nb_{0.80}Ta_{0.20})O₃, the powders were wet-mixed for 20 hours.

The resultant slurry was, similarly to Example 1, passed through addition of a binder and a plasticizer, mixing, forming, degreasing and heating (firing) to produce a ceramic. This is designated as Sample C3.

That is, Sample C3 was produced in the same manner as Sample E2 of Example 2 except that the plate-like NN powder (template) was not used.

### Comparative Example 4

In the ceramic of this Example, the main phase is a polycrystalline sintered body comprising {Li_{0.03}(K_{0.5}Na_{0.5})_{0.97}}(Nb_{0.80}Ta_{0.20})O₃ similarly to Samples E1 and E2. The ceramic of this Example contains not additional element.

In this Example, similarly to Example 1, the plate-like NN powder, non-plate-like NN powder, KN powder, KT powder and LT powder were blended at a stoichiometric ratio of giving the objective composition, that is, {Li_{0.03}(K_{0.5}Na_{0.5})_{0.97}}(Nb_{0.80}Ta_{0.20})O₃, and then wet-mixed for 20 hours.

The resultant slurry was, similarly to Example 1, passed through addition of a binder and a plasticizer, mixing, forming, degreasing and heating (firing) to produce a ceramic. This is designated as Sample C4.

That is, Sample C4 was produced in the same manner as Sample E1 of Example 1 except that an additional element was not blended.

### Comparative Example 5

In the ceramic of this Example, the main phase is a polycrystalline sintered body comprising {Li_{0.04}(K_{0.5}Na_{0.5})_{0.96}}(Nb_{0.86}Ta_{0.10}Sb_{0.04})O₃ similarly to Samples E3 to E9 produced in Examples 3 to 9. The ceramic of this Example is produced by neither using the plate-like NN powder (template) nor adding an additional element.

In this Example, the non-plate-like NN powder, KN powder, KT powder and LS powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and then wet-mixed for 20 hours.

The resultant slurry was, similarly to Example 1, passed through addition of a binder and a plasticizer, mixing, forming, degreasing and heating (firing) to produce a ceramic. This is designated as Sample C5.

That is, Sample C5 was produced in the same manner as Samples E3 to E9 except that an additional element was not blended and the plate-like NN powder was not used.

### Comparative Example 6

In the ceramic of this Example, the main phase is a polycrystalline sintered body, similarly to Sample E3 of Example 3, comprising {Li_{0.04}(K_{0.5}Na_{0.5})_{0.96}}(Nb_{0.86}Ta_{0.10}Sb_{0.04})O₃ and containing In. The ceramic of this Example is produced by not using the plate-like NN powder (template).

In this Example, the non-plate-like NN powder, KN powder, KT powder and LT powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an In₂O₃ powder having a purity of 99.99% or more, which is a compound containing In working out to an additional element, was further blended at a ratio of 0.005 mol per mol of {Li_{0.04}(K_{0.5}Na_{0.5})_{0.96}}(Nb_{0.86}Ta_{0.10}Sb_{0.04})O₃, the powders were wet-mixed for 20 hours.

The resultant slurry was, similarly to Example 1, passed through addition of a binder and a plasticizer, mixing, forming, degreasing and heating (firing) to produce a ceramic. This is designated as Sample C6.

That is, Sample C3 was produced in the same manner as Sample E3 except that the plate-like NN powder was not used.

### Comparative Example 7

In the ceramic of this Example, the main phase is a polycrystalline sintered body comprising, similarly to Sample E4 of Example 4, {Li_{0.04}(K_{0.5}Na_{0.5})_{0.96}}(Nb_{0.86}Ta_{0.10}Sb_{0.04})O₃ having added thereto Ca so as to replace a part of K and Na. The ceramic of this Example is produced by not using the plate-like NN powder (template).

In this Example, the non-plate-like NN powder, KN powder, KT powder and LS powder were prepared. Also, a CaCO₃ powder having a purity of 99.99% or more, which is a compound containing Ca working out to an additional element, was prepared.

These powders were blended at a stoichiometric ratio of giving a composition of {Li_{0.04}(K_{0.5}Na_{0.5})_{0.94}Ca_{0.01}}(Nb_{0.86}Ta_{0.10}Sb_{0.04})O₃ resulting from addition of Ca to replace a part of K and Na of {Li_{0.04}(K_{0.5}Na_{0.5})_{0.96}}(Nb_{0.86}Ta_{0.10}Sb_{0.04})O₃, and then wet-mixed for 20 hours.

The resultant slurry, similarly to Example 1, passed through addition of a binder and a plasticizer, mixing, forming, degreasing and heating (firing) to produce a ceramic. This is designated as Sample C7.

That is, Sample C7 was produced in the same manner as Sample E4 except that the plate-like NN powder was not used.

### Comparative Example 8

In the ceramic of this Example, the main phase is a polycrystalline sintered body, similarly to Sample E5 of Example 5, comprising {Li_{0.04}(K_{0.5}Na_{0.5})_{0.96}}(Nb_{0.86}Ta_{0.10}Sb_{0.04})O₃ and containing Si. The ceramic of this Example is produced by not using the plate-like NN powder (template).

In this Example, the non-plate-like NN powder, KN powder, KT powder and LS powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an SiO₂ powder having a purity of 99.99% or more, which is a compound containing Si working out to an additional element, was further blended at a ratio of 0.01 mol per mol of {Li_{0.04}(K_{0.5}Na_{0.5})_{0.96}}(Nb_{0.86}Ta_{0.10}Sb_{0.04})O₃, the powders were wet-mixed for 20 hours.

The resultant slurry was, similarly to Example 1, passed through addition of a binder and a plasticizer, mixing, forming, degreasing and heating (firing) to produce a ceramic. This is designated as Sample C8.

That is, Sample C8 was produced in the same manner as Sample E5 except that the plate-like NN powder was not used.

### Comparative Example 9

In the ceramic of this Example, the main phase is a polycrystalline sintered body, similarly to Sample E6 of Example 6, comprising {Li_{0.04}(K_{0.5}Na_{0.5})_{0.96}}(Nb_{0.66}Ta_{0.10}Sb_{0.04})O₃ and containing Ag. The ceramic of this Example is produced by not using the plate-like NN powder (template).

In this Example, the non-plate-like NN powder, KN powder, KT powder and LS powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after an Ag₂O powder having a purity of 99.99% or more, which is a compound containing Ag working out to an additional element, was further blended at a ratio of 0.005 mol per mol of {Li_{0.04}(K_{0.5}Na_{0.5})_{0.96}}(Nb_{0.86}Ta_{0.10}Sb_{0.04})O₃, the powders were wet-mixed for 20 hours.

The resultant slurry, similarly to Example 1, passed through addition of a binder and a plasticizer, mixing, forming, degreasing and heating (firing) to produce a ceramic. This is designated as Sample C9.

That is, Sample C9 was produced in the same manner as Sample E6 except that the plate-like NN powder was not used.

### Comparative Example 10

In the ceramic of this Example, the main phase is a polycrystalline sintered body, similarly to Sample E8 of Example 8, comprising {Li_{0.04}(K_{0.5}Na_{0.5})_{0.96}}(Nb_{0.86}Ta_{0.10}Sb_{0.04})O₃ having added thereto Si so as to replace a part of K and Na. The ceramic of this Example is produced by not using the plate-like NN powder (template).

In this Example, the non-plate-like NN powder, KN powder, KT powder and LS powder were prepared. Also, an SrCO₃ powder having a purity of 99.99% or more, which is a compound containing Sr working out to an additional element, was prepared.

These powders were blended at a stoichiometric ratio of giving a composition of {Li_{0.04}(K_{0.5}Na_{0.5})_{0.94}Sr_{0.01}}(Nb_{0.86}Ta_{0.10}Sb_{0.04})O₃ resulting from addition of Sr to replace a part of K and Na of {Li_{0.04}(K_{0.5}Na_{0.5})_{0.96}}(Nb_{0.86}Ta_{0.10}Sb_{0.04})O₃, and then wet-mixed for 20 hours.

The resultant slurry was, similarly to Example 1, passed through addition of a binder and a plasticizer, mixing, forming, degreasing and heating (firing) to produce a ceramic. This is designated as Sample C10.

That is, Sample C10 was produced in the same manner as Sample E8 except that the plate-like NN powder was not used.

### Comparative Example 11

In the ceramic of this Example, the main phase is a polycrystalline sintered body, similarly to Sample E9 of Example 9, comprising {Li_{0.04}(K_{0.5}Na_{0.5})_{0.96}}(Nb_{0.86}Ta_{0.10}Sb_{0.04})O₃ and containing Pd. The ceramic of this Example is produced by not using the plate-like NN powder (template).

In this Example, the non-plate-like NN powder, KN powder, KT powder and LS powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and after a PdO powder having a purity of 99.99% or more, which is a compound containing Pd working out to an additional element, was further blended at a ratio of 0.01 mol per mol of {Li_{0.04} (K_{0.5}Na_{0.5})_{0.96}}(Nb_{0.86}Ta_{0.10}Sb_{0.04})O₃, the powders were wet-mixed for 20 hours.

The resultant slurry, similarly to Example 1, passed through addition of a binder and a plasticizer, mixing, forming, degreasing and heating (firing) to produce a ceramic. This is designated as Sample C11.

That is, Sample C11 was produced in the same manner as Sample E9 except that the plate-like NN powder was not used.

### Comparative Example 12

In the ceramic of this Example, the main phase is a polycrystalline sintered body comprising {Li_{0.04}(K_{0.5}Na_{0.5})_{0.96}}(Nb_{0.86}Ta_{0.10}Sb_{0.04})O₃ similarly to Samples E3 to E9 produced in Examples 3 to 9. The ceramic of this Example is produced by not adding an additional element.

In this Example, similarly to Example 3, the plate-like NN powder, non-plate-like NN powder, KN powder, KT powder and LS powder were prepared.

These powders were blended at a stoichiometric ratio of giving the objective composition, that is, {Li_{0.04}(K_{0.5}Na_{0.5})_{0.96}}(Nb_{0.86}Ta_{0.10}Sb_{0.04})O₃, and then wet-mixed for 20 hours.

The resultant slurry, similarly to Example 1, passed through addition of a binder and a plasticizer, mixing, forming, degreasing and heating (firing) to produce a ceramic. This is designated as Sample C12.

That is, Sample C12 was produced in the same manner as Samples E3 to E9 except that an additional element was not blended.

### Comparative Example 13

In the ceramic of this Example, the main phase is a polycrystalline sintered body, similarly to Sample E11 produced in Example 11, comprising {Li_{0.75}(K_{0.45}Na_{0.55})_{0.925}}(Nb_{0.83}Ta_{0.095}Sb_{0.075})O₃. The ceramic of this Example contains no additional element.

In this Example, a plate-lie NN powder was prepared in the same manner as in Example 1.

Subsequently, an (Li_{0.079}K_{0.438}Na_{0.483}) (Nb_{0.821}Ta_{0.100}Sb_{0.079})O₃ powder was produced by a solid-phase reaction process where a mixture containing an Na₂CO₃ powder, a K₂CO₃ powder, an Li₂CO₃ powder, an Nb₂O₅ powder, a Ta₂O₅ powder and an Sb₂O₅ powder each in a predetermined amount and each having a purity of 99.99% or more was heated at a temperature of 750° C. for 5 hours and the reaction product was ground in a ball mill.

Thereafter, the plate-like NN powder and the (Li_{0.079}K_{0.438}Na_{0.483})(Nb_{0.821}Ta_{0.100}Sb_{0.079})O₃ powder were blended at a stoichiometric ratio of giving the objective composition, that is, {Li_{0.75}(K_{0.45}Na_{0.55})_{0.925}}(Nb_{0.83}Ta_{0.095}Sb_{0.075})O₃, and then wet-mixed for 20 hours.

Here, the plate-like NN powder (template) was blended, similarly to Example 1, in an amount such that Na in an amount corresponding to 5 atm % of the elements occupying the A site of {Li_{0.75}(K_{0.45}Na_{0.55})_{0.925}}(Nb_{0.83}Ta_{0.095}Sb_{0.075})O₃ synthesized from starting materials was supplied from the plate-like NN powder.

The resultant slurry was, similarly to Example 1, passed through addition of a binder and a plasticizer, mixing, forming, degreasing and heating (firing) to produce a dense ceramic having a relative density of 95% or more. This is designated as Sample C13.

That is, Sample C13 was produced in the same manner as Sample E11 except that an additional element was not blended.

### Test Example

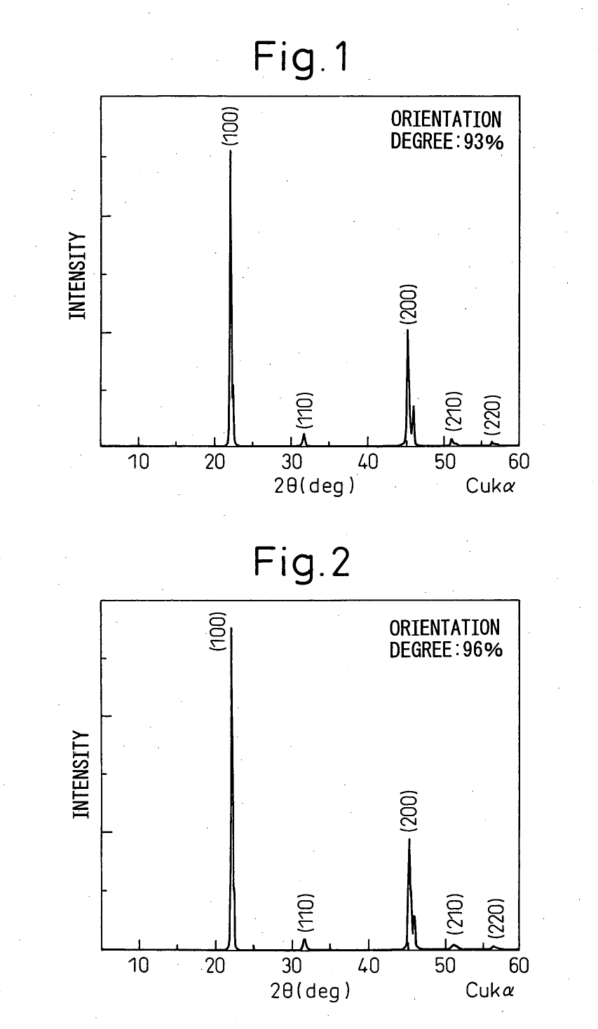

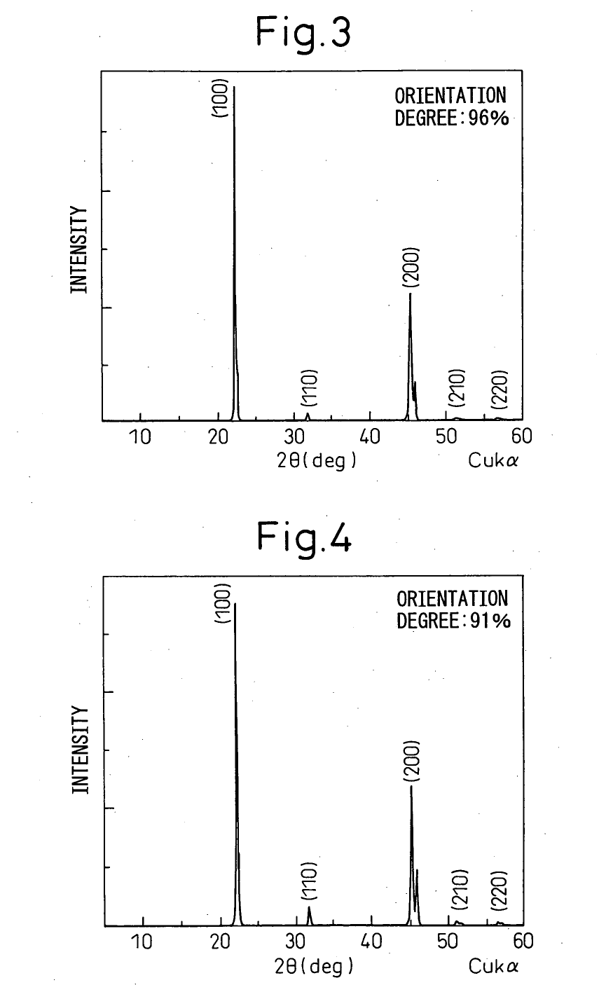

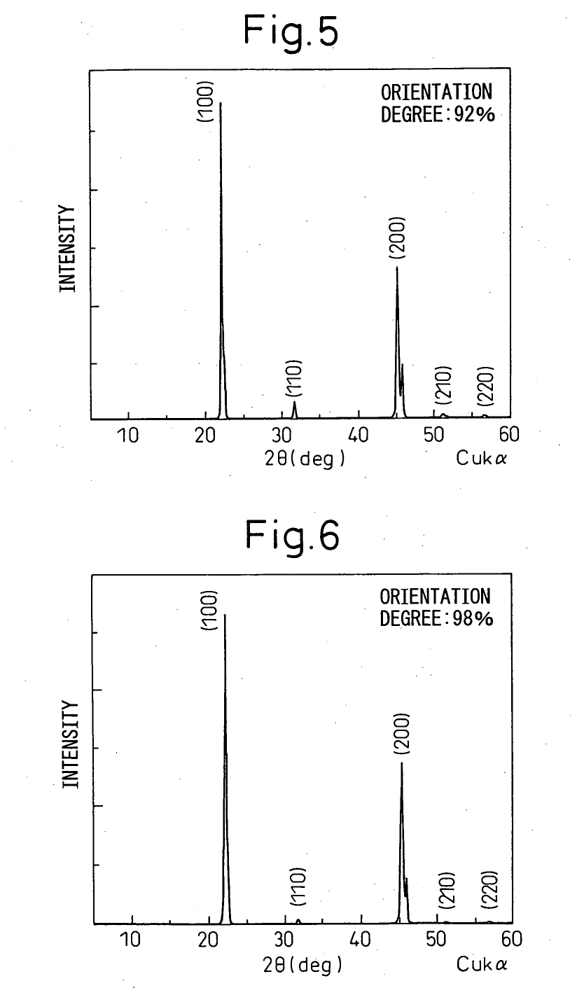

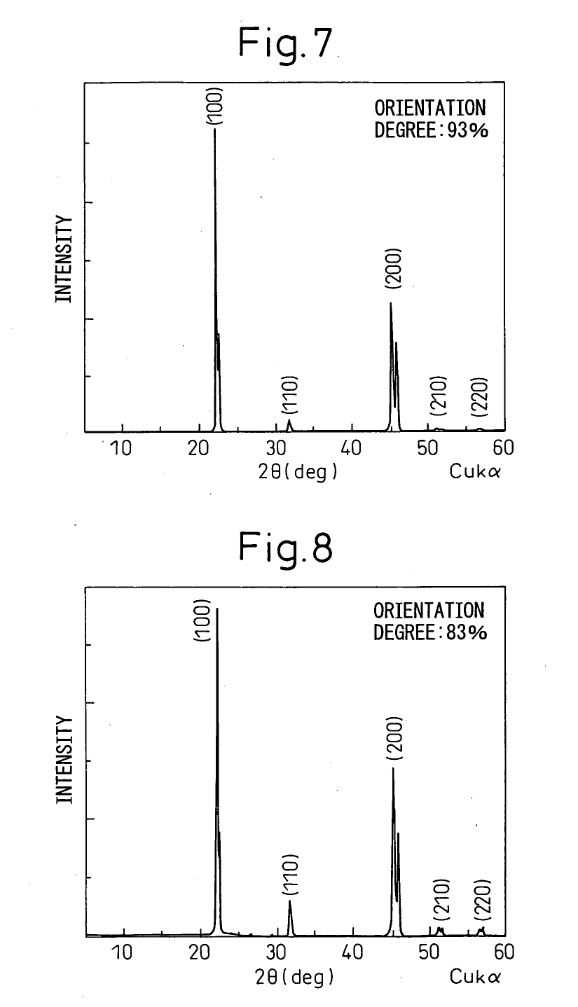

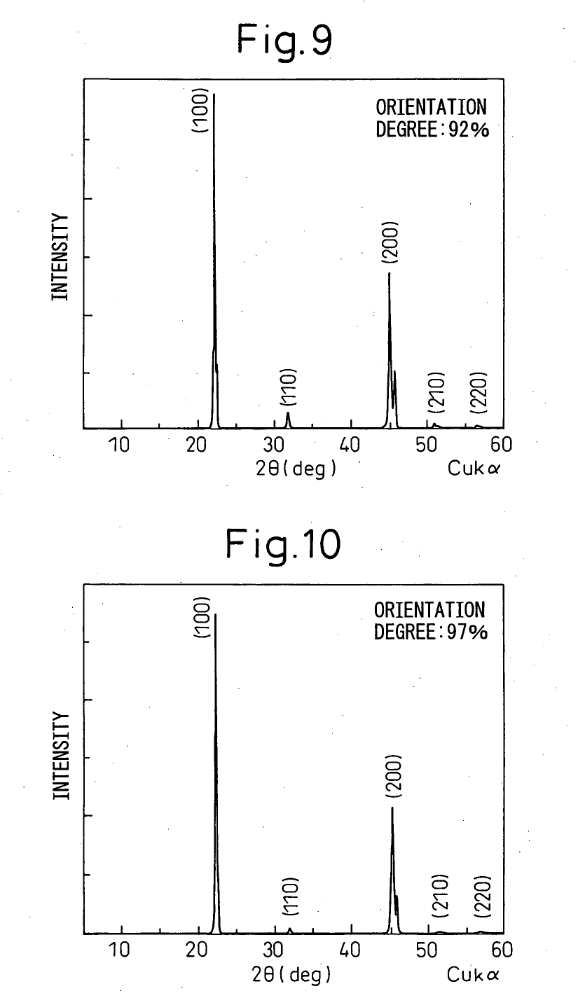

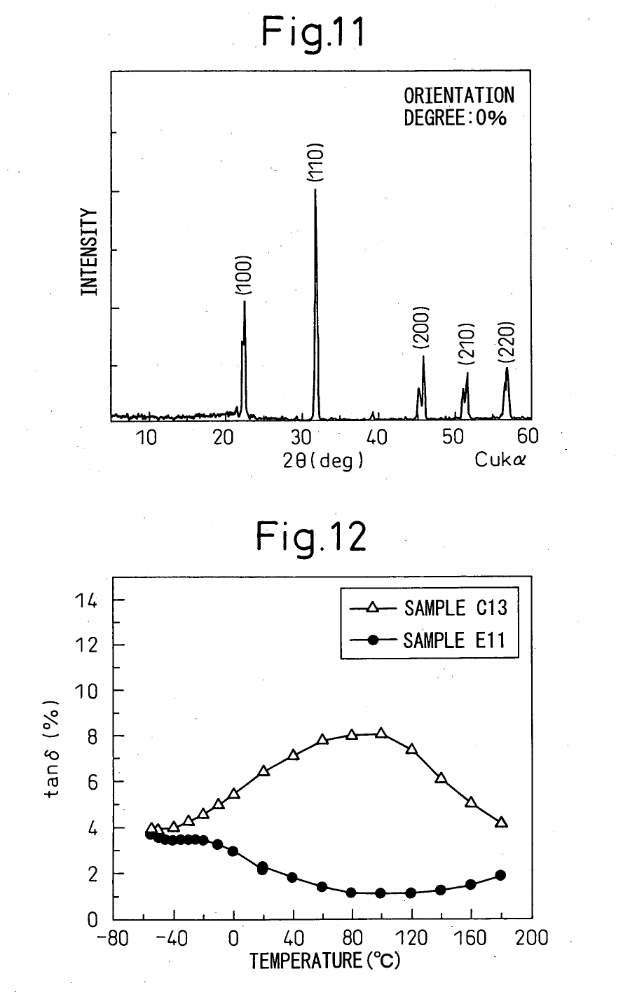

In this Example, Samples E1 to E10 and Sample C2 were subjected to X-ray diffraction measurement. FIGS. 1 to 11 show an X-ray diffraction pattern measured for a plane parallel to the tape-casting plane of each sample.

As seen from FIGS. 1 to 11, in Samples E1 to E10 produced by using the plate-like NN powder as a template, the pseudo-cubic {100} plane is oriented at a remarkably high orientation degree as compared with Sample C2.

Then, the orientation degree of {100} plane and the piezoelectric properties of Samples E1 to E10 and Samples C1 to C12 produced in Examples 1 to 10 and Comparative Examples 1 to 12 were evaluated as follows.

[Orientation Degree]

The average orientation degree F(100) of the {100} plane by the Lotgering's method was measured for the plane parallel to the tape-casting plane of each polycrystalline sintered sample.

The average orientation degree F(100) was calculated according to mathematical formula 1. The results obtained are shown in Tables 1 and 2 below.

[Piezoelectric Properties]

As the piezoelectric properties, the piezoelectric d₃₁ constant, electromechanical coupling factor Kp and piezoelectric g₃₁ constant of Samples E1 to E10 and Samples C1 to C12 were measured.

As for the measuring method, a disc-like sample having a thickness of 0.7 mm and a diameter of 11 mm with top and bottom planes being parallel to the tape-casting plane was produced from each polycrystalline sintered sample through cutting, polishing and machining. The top and bottom planes of each disc-like sample were coated with an Au electrode by sputtering and after applying a poling process in the vertical direction of the disc-like sample, the piezoelectric properties were measured at room temperature by a resonance-antiresonance method under the condition that the electric field intensity was 1 V/mm. The results obtained are shown in Tables 1 and 2 below.

Also, the piezoelectric properties of Sample E11 and Sample C13 were examined as follows.

A disc-like sample having a thickness of 0.485 mm and a diameter of 8.5 mm with top and bottom planes being parallel to the tape-casting plane was produced from each polycrystalline sintered sample of Sample E11 and Sample C13 through cutting, polishing and machining. Subsequently, the top and bottom planes of each disc-like sample were printed with an Au electrode paste (ALP3057, produced by Sumitomo Metal Mining Co., Ltd.) and then baked under heating at a temperature of 850° C. for 10 minutes in a mesh belt-type furnace to form an electrode with a thickness of 0.01 mm. After applying a poling process in the vertical direction of the disc-like sample, the piezoelectric d₃₁ constant, electromechanical coupling factor Kp, piezoelectric g₃₁ constant and dielectric loss tan δ as piezoelectric properties were measured by a resonance-antiresonance method under the condition that the electric field intensity was 1 V/mm.

In the measurement of dielectric loss tan δ, the dielectric loss tan δ was measured by changing the temperature to examine the temperature dependency of the dielectric loss tan δ.

As for Sample E11 and Sample C13, the results of piezoelectric d₃₁ constant, electromechanical coupling factor Kp and piezoelectric g₃₁ constant are shown in Tables 1 and 2 below, and the results of dielectric loss tan δ are shown in FIG. 12.

TABLE 1

| | Composition | | | | | Amount | Presence | Orien- | | | |
|---|---|---|---|---|---|---|---|---|---|---|---|
| | | | | | Additional | of | or Absence | tation | | | |
| | | | | | Element | Template | of Orien- | Degree | d₃₁ | | g₃₁ |
| Sample No. | x | y | z | w | kind | (atm %) | tation | (%) | (pm/V) | Kp | (×10⁻³ Vm/N) |
| Sample E1 | 0.03 | 0.5 | 0.2 | 0 | Pd | 5 | present | 93 | 133 | 0.685 | 21.3 |
| Sample E2 | 0.03 | 0.5 | 0.2 | 0 | Ni | 5 | present | 96 | 104 | 0.620 | 21.0 |
| Sample E3 | 0.04 | 0.5 | 0.1 | 0.04 | In | 5 | present | 96 | 137 | 0.713 | 21.2 |
| Sample E4 | 0.04 | 0.5 | 0.1 | 0.04 | Ca | 5 | present | 91 | 136 | 0.586 | 10.5 |
| Sample E5 | 0.04 | 0.5 | 0.1 | 0.04 | Si | 5 | present | 92 | 128 | 0.593 | 13.2 |
| Sample E6 | 0.04 | 0.5 | 0.1 | 0.04 | Ag | 5 | present | 98 | 149 | 0.707 | 21.4 |
| Sample E7 | 0.04 | 0.5 | 0.1 | 0.04 | Ag | 5 | present | 93 | 132 | 0.586 | 12.0 |
| Sample E8 | 0.04 | 0.5 | 0.1 | 0.04 | Sr | 5 | present | 78 | 113 | 0.531 | 808 |
| Sample E9 | 0.04 | 0.5 | 0.1 | 0.04 | Pd | 5 | present | 92 | 142 | 0.633 | 13.2 |
| Sample E10 | 0.04 | 0.54 | 0.1 | 0.04 | Pd | 5 | present | 97 | 151 | 0.683 | 17.9 |
| Sample E11 | 0.075 | 0.55 | 0.095 | 0.075 | Mn | 5 | present | 93 | 87 | 0.519 | 9.8 |

TABLE 2

| | Composition | | | | | Amount | Presence | Orien- | | | |
|---|---|---|---|---|---|---|---|---|---|---|---|
| | | | | | Additional | of | or Absence | tation | | | |
| | | | | | Element | Template | of Orien- | Degree | d₃₁ | | g₃₁ |
| Sample No. | x | y | z | w | kind | (atm %) | tation | (%) | (pm/V) | Kp | (×10⁻³ Vm/N) |
| Sample C1 | 0.03 | 0.5 | 0.2 | 0 | — | 0 | none | 0 | 100 | 0.505 | 9.0 |
| Sample C2 | 0.03 | 0.5 | 0.2 | 0 | Pd | 0 | none | 0 | 106 | 0.520 | 9.0 |
| Sample C3 | 0.03 | 0.5 | 0.2 | 0 | Ni | 0 | none | 0 | 94 | 0.470 | 7.8 |
| Sample C4 | 0.03 | 0.5 | 0.2 | 0 | — | 5 | present | 95 | 126 | 0.618 | 17.1 |
| Sample C5 | 0.04 | 0.5 | 0.1 | 0.04 | — | 0 | none | 0 | 96 | 0.452 | 7.8 |
| Sample C6 | 0.04 | 0.5 | 0.1 | 0.04 | In | 0 | none | 0 | 106 | 0.498 | 8.5 |
| Sample C7 | 0.04 | 0.5 | 0.1 | 0.04 | Ca | 0 | none | 0 | 106 | 0.484 | 7.6 |
| Sample C8 | 0.04 | 0.5 | 0.1 | 0.04 | Si | 0 | none | 0 | 97 | 0.470 | 8.0 |
| Sample C9 | 0.04 | 0.5 | 0.1 | 0.04 | Ag | 0 | none | 0 | 99 | 0.466 | 7.6 |
| Sample C10 | 0.04 | 0.5 | 0.1 | 0.04 | Sr | 0 | none | 0 | 102 | 0.480 | 7.6 |
| Sample C11 | 0.04 | 0.5 | 0.1 | 0.04 | Pd | 0 | none | 0 | 112 | 0.531 | 8.7 |
| Sample C12 | 0.04 | 0.5 | 0.1 | 0.04 | — | 5 | present | 94 | 113 | 0.554 | 13.9 |
| Sample C13 | 0.075 | 0.55 | 0.095 | 0.075 | — | 5 | present | 83 | 81 | 0.449 | 7.7 |

As can be seen from Table 1, in the grain oriented ceramic of Samples E1 to E10, the pseudo-cubic {100} plane was oriented parallel to the tape plane. As for the average orientation degree of the pseudo-cubic {100} plane by Lotgering's method, a high orientation degree of 78% or more was exhibited. Also, Samples E1 to E10 exhibited excellent piezoelectric properties in that the piezoelectric d₃₁ constant was 104 pm/V or more, the electromechanical coupling factor Kp was 0.531 or more and the piezoelectric g₃₁ constant was 8.8×10⁻³ Vm/N or more.

In addition, as can be seen from Tables 1 and 2, in Sample E1, the piezoelectric d₃₁ constant, electromechanical coupling factor Kp and piezoelectric g₃₁ constant were enhanced to 1.33 times, 1.36 times and 2.37 times, respectively, as compared with Sample C1 which had the same composition but was not oriented and in which an additional element was not added. Also, in Sample E1, the piezoelectric d₃₁ constant, electromechanical coupling factor Kp and piezoelectric g₃₁ constant were enhanced to 1.25 times, 1.32 times and 2.36 times, respectively, as compared with Sample C2 which had the same composition and in which additional element Pd was added but which was not oriented. Furthermore, in Sample E1, the piezoelectric d₃₁ constant, electromechanical coupling factor Kp and piezoelectric g₃₁ constant were enhanced to 1.06 times, 1.11 times and 1.25 times, respectively, as compared with Sample C4 which had the same composition and was oriented but in which an additional element was not added.

In Sample E2, the piezoelectric d₃₁ constant, electromechanical coupling factor Kp and piezoelectric g₃₁ constant were enhanced to 1.04 times, 1.23 times and 2.33 times, respectively, as compared with Sample C1 which had the same composition but was not oriented and in which an additional element was not added. Also, in Sample E2, the piezoelectric d₃₁ constant, electromechanical coupling factor Kp and piezoelectric g₃₁ constant were enhanced to 1.11 times, 1.32 times and 2.69 times, respectively, as compared with Sample C3 which had the same composition and in which additional element Ni was added but which was not oriented.

In Sample E3, the piezoelectric d₃₁ constant, electromechanical coupling factor Kp and piezoelectric g₃₁ constant were enhanced to 1.43 times, 1.58 times and 2.72 times, respectively, as compared with Sample C5 which had the same composition but was not oriented and in which an additional element was not added. Also, in Sample E3, the piezoelectric d₃₁ constant, electromechanical coupling factor Kp and piezoelectric g₃₁ constant were enhanced to 1.29 times, 1.43 times and 2.50 times, respectively, as compared with Sample C6 which had the same composition and in which additional element In was added but which was not oriented. Furthermore, in Sample E3, the piezoelectric d₃₁ constant, electromechanical coupling factor Kp and piezoelectric g₃₁ constant were enhanced to 1.21 times, 1.29 times and 1.53 times, respectively, as compared with Sample C12 which had the same composition and was oriented but in which an additional element was not added.

In Sample E4, the piezoelectric d₃₁ constant, electromechanical coupling factor Kp and piezoelectric g₃₁ constant were enhanced to 1.42 times, 1.30 times and 1.35 times, respectively, as compared with Sample C5 which had the same composition but was not oriented and in which an additional element was not added. Also, in Sample E3, the piezoelectric d₃₁ constant, electromechanical coupling factor Kp and piezoelectric g₃₁ constant were enhanced to 1.28 times, 1.21 times and 1.37 times, respectively, as compared with Sample C7 which had the same composition and in which additional element Ca was added but which was not oriented.

In Sample E5, the piezoelectric d₃₁ constant, electromechanical coupling factor Kp and piezoelectric g₃₁ constant were enhanced to 1.33 times, 1.31 times and 1.69 times, respectively, as compared with Sample C5 which had the same composition but was not oriented and in which an additional element was not added. Also, in Sample E5, the piezoelectric d₃₁ constant, electromechanical coupling factor Kp and piezoelectric g₃₁ constant were enhanced to 1.33 times, 1.26 times and 1.65 times, respectively, as compared with Sample C8 which had the same composition and in which additional element Si was added but which was not oriented.

In Sample E6, the piezoelectric d₃₁ constant, electromechanical coupling factor Kp and piezoelectric g₃₁ constant were enhanced to 1.55 times, 1.56 times and 2.74 times, respectively, as compared with Sample C5 which had the same composition but was not oriented and in which an additional element was not added. Also, in Sample E6, the piezoelectric d₃₁ constant, electromechanical coupling factor Kp and piezoelectric g₃₁ constant were enhanced to 1.50 times, 1.52 times and 2.81 times, respectively, as compared with Sample C9 which had the same composition and in which additional element Ag was added but which was not oriented.

Furthermore, in Sample E6, the piezoelectric d₃₁ constant, electromechanical coupling factor Kp and piezoelectric g₃₁ constant were enhanced to 1.13 times, 1.21 times and 1.78 times, respectively, as compared with Sample E7 which had the same composition and in which the same additional element Ag was added but which was differing in the orientation degree. This reveals that as the orientation degree becomes higher, the piezoelectric properties are more enhanced.

In Sample E7, the piezoelectric d₃₁ constant, electromechanical coupling factor Kp and piezoelectric g₃₁ constant were enhanced to 1.38 times, 1.30 times and 1.54 times, respectively, as compared with Sample C5 which had the same composition but was not oriented and in which an additional element was not added. Also, in Sample E7, the piezoelectric d₃₁ constant, electromechanical coupling factor Kp and piezoelectric g₃₁ constant were enhanced to 1.33 times, 1.26 times and 1.57 times, respectively, as compared with Sample C9 which had the same composition and in which additional element Ag was added but which was not oriented.

In Sample E8, the piezoelectric d₃₁ constant, electromechanical coupling factor Kp and piezoelectric g₃₁ constant were enhanced to 1.18 times, 1.17 times and 1.13 times, respectively, as compared with Sample C5 which had the same composition but was not oriented and in which an additional element was not added. Also, in Sample E8, the piezoelectric d₃₁ constant, electromechanical coupling factor Kp and piezoelectric g₃₁ constant were enhanced to 1.11 times, 1.11 times and 1.16 times, respectively, as compared with Sample C10 which had the same composition and in which additional element Sr was added but which was not oriented.

In Sample E9, the piezoelectric d₃₁ constant, electromechanical coupling factor Kp and piezoelectric g₃₁ constant were enhanced to 1.48 times, 1.40 times and 1.69 times, respectively, as compared with Sample C5 which had the same composition but was not oriented and in which an additional element was not added. Also, in Sample E9, the piezoelectric d₃₁ constant, electromechanical coupling factor Kp and piezoelectric g₃₁ constant were enhanced to 1.26 times, 1.19 times and 1.51 times, respectively, as compared with Sample C11 which had the same composition and in which additional element Pd was added but which was not oriented.

Sample E10 is a grain oriented ceramic comprising {Li_{0.04}(K_{0.46}Na_{0.54})_{0.96}}(Nb_{0.86}Ta_{0.10}Sb_{0.04})O₃ and contains additional element Pd. In Sample E10, the piezoelectric d₃₁ constant, electromechanical coupling factor Kp and piezoelectric g₃₁ constant were enhanced to 1.07 times, 1.08 times and 1.35 times, respectively, as compared with Sample E9 in which the K/Na ratio in the A-site elements was 1:1.

In Sample E11, the piezoelectric d₃₁ constant, electromechanical coupling factor Kp and piezoelectric g₃₁ constant were enhanced to 1.08 times, 1.16 times and 1.28 times, respectively, as compared with Sample C13 which had the same composition and was oriented but in which an additional element was not added. Also, as seen from FIG. 12, in Sample E11, a small absolute value of the dielectric loss tan δ and less fluctuation due to temperature were exhibited as compared with Sample C13 and thus, the temperature dependency of tan δ was improved.

In this way, it is verified that, in Samples E1 to E11, piezoelectric properties can be improved by orienting a certain plane and adding an additional element.

The embodiments of the present invention are described in detail in the foregoing pages, but the present invention is not limited thereto and various modifications and changes can be made therein without departing from the purport of the present invention.

For example, in Examples above, when an element is added, the objective element is added by using an oxide, but a metal, an oxide comprising an element differing in the valence number from that in Examples, a carbonate, a nitrate, a metal alkoxide or the like may also be used.

1. A grain oriented ceramic comprising, as the main phase, an isotropic perovskite-type compound which is represented by formula (1): {Liₓ(K_{1-y}Na_{y})₁₋ₓ}(Nb_{1-z-w}Ta_{z}Sb_{w})O₃ in which x, y, z and w are in respective composition ranges of 0≦x≦0.2, 0≦y≦1, 0≦z≦0.4, 0≦w≦0.2 and x+z+w>0,
wherein
said main phase comprises a polycrystalline body containing from 0.0001 to 0.15 mol of any one or more additional element selected from metal elements, semi-metal elements, transition metal elements, noble metal elements and alkaline earth metal elements belonging to Groups 2 to 15 of the Periodic Table, per mol of the compound represented by formula (1), and
a specific crystal plane of each crystal grain constituting said polycrystalline body is oriented.

2. The grain oriented ceramic as claimed in claim 1, wherein said additional element is contained in said crystal grain constituting said polycrystalline body and/or at the grain boundary.

3. The grain oriented ceramic as claimed in claim 1, wherein said additional element is added at a ratio of 0.01 to 15 atm % by replacing any one or more element selected from Li, K, Na, Nb, Ta and Sb in said isotropic perovskite-type compound represented by formula (1).

4. The grain oriented ceramic as claimed in claim 1, wherein said additional element is any one or more element selected from Mg, Ca, Sr and Ba.

5. The grain oriented ceramic as claimed in claim 1, wherein said additional element is any one or more element selected from Sc, Ti, V, Cr, Mn, Fe, Co, Ni, Cu, Zn, Y, Zr, Mo, Hf, W and Re.

6. The grain oriented ceramic as claimed in claim 1, wherein said additional element is any one or more element selected from Pd, Ag, Ru, Rh, Pt, Au, Ir and Os.

7. The grain oriented ceramic as claimed in claim 1, wherein said additional element is any one or more element selected from B, Al, Ga, In, Si, Ge, Sn and Bi.

8. The grain oriented ceramic as claimed in claim 1, wherein the orientation degree of a pseudo-cubic (100) plane in said polycrystalline body is 30% or more as measured by the Lotgering's method.

9. The grain oriented ceramic as claimed in claim 1, wherein said grain oriented ceramic has a piezoelectric d₃₁ constant 1.1 times or more that of a non-oriented ceramic which comprises a polycrystalline body having the same composition as said grain oriented ceramic and in which the crystal plane of the grain constituting said polycrystalline body is not oriented.

10. The grain oriented ceramic as claimed in claim 1, wherein said grain oriented ceramic has an electromechanical coupling factor Kp 1.1 times or more that of a non-oriented ceramic which comprises a polycrystalline body having the same composition as said grain oriented ceramic and in which the crystal plane of the grain constituting said polycrystalline body is not oriented.

11. The grain oriented ceramic as claimed in claim 1, wherein said grain oriented ceramic has a piezoelectric g₃₁ constant 1.1 times or more that of a non-oriented ceramic which comprises a polycrystalline body having the same composition as said grain oriented ceramic and in which the crystal plane of the grain constituting said polycrystalline body is not oriented.

12. A piezoelectric element comprising a piezoelectric material comprising the grain oriented ceramic claimed in claim 1.

13. A dielectric element comprising a dielectric material comprising the grain oriented ceramic claimed in claim 1.

14. A thermoelectric conversion element comprising a thermoelectric conversion material comprising the grain oriented ceramic claimed in claim 1.

15. An ion conducting element comprising an ion conducting material comprising the grain oriented ceramic claimed in claim 1.

16. A method for producing a grain oriented ceramic, comprising:
a mixing step of mixing (i) a first anisotropically shaped powder comprising orienting particles having an orienting plane where a specific crystal plane is oriented, (ii) a first reaction raw material of reacting with said first anisotropically shaped powder to produce an isotropic perovskite-type compound represented by formula (1): {Liₓ(K_{1-y}Na_{y})₁₋ₓ}(Nb_{1-z-w}Ta_{z}Sb_{w})O₃ wherein 0≦x≦0.2, 0≦y≦1, 0≦z≦0.4, 0≦w≦0.2 and x+z+w>0, and (iii) any one or more additional element selected from metal elements, semi-metal elements, transition metal elements, noble metal elements and alkaline earth metal elements belonging to Groups 2 to 15 of the Periodic Table, thereby producing a raw material mixture,
a forming step of forming said raw material mixture such that said orienting plane of said first anisotropically shaped powder is oriented nearly in the same direction in the formed body, and
a heat-treating step of heating said formed body to react said first anisotropically shaped powder and said first reaction raw material and to thereby produce a polycrystalline body which comprises said isotropic perovskite-type compound represented by formula (1) and of which the crystal grains are oriented to show a textured structure, wherein
in said mixing step, said additional element is added in an amount of 0.0001 to 0.15 mol per mol of the compound represented by formula (1), and
said orienting plane of said orienting particles has a lattice matching with the specific plane oriented in the crystal grain constituting said polycrystalline body obtained in said heat-treating step.

17. The method for producing a grain oriented ceramic as claimed in claim 16, wherein said orienting particles have a plate-like shape.

18. The method for producing a grain oriented ceramic as claimed in claim 16, wherein said orienting particles comprise a compound represented by formula (2): Liₓ(K_{1-y}Na_{y})₁₋ₓ}(Nb_{1-z-w}Ta_{z}Sb_{w})O₃ wherein 0≦x≦1, 0≦y≦1, 0≦z≦1 and 0≦w≦1.

19. The method for producing a grain oriented ceramic as claimed in claim 16, wherein said orienting plane of said orienting particles is a pseudo-cubic (100) plane.

20. The method for producing a grain oriented ceramic as claimed in claim 16, wherein said additional element is any one or more element selected from Mg, Ca, Sr, Ba, Sc, Ti, V, Cr, Mn, Fe, Co, Ni, Cu, Zn, Y, Zr, Mo, Ru, Rh, Pd, Ag, Hf, W, Re, Pt, Au, Ir, Os, B, Al, Ga, In, Si, Ge, Sn and Bi.
